(19) United States
(12) Patent Application Publication
(10) Pub. No.: US 2025/0128101 A1
(43) Pub. Date: Apr. 24, 2025

(54) SYSTEMS AND METHODS OF AUTOMATED SPRINKLER SYSTEM DIAGNOSTICS AND TESTING

(71) Applicant: Tyco Fire & Security GmbH, Neuhausen am Rheinfall (CH)

(72) Inventors: Jesse D. Nercessian, Allendale, NJ (US); Emilie Gorzoch, Milwaukee, WI (US); Matthew E. Heidler, Milwaukee, WI (US); Arjun Gadmollu Janardhanasetty, Bangalore (IN); Sivaraman Chandrasekharan, Kanyakumari (IN); Udhayakumar Sathiyanathan, Bangalore (IN); Sujith Kumar Surendran, Bengaluru (IN); Harish Subhash Vernekar, Belgaum (IN)

(21) Appl. No.: 18/919,299

(22) Filed: Oct. 17, 2024

Related U.S. Application Data
(60) Provisional application No. 63/562,476, filed on Mar. 7, 2024.

(30) Foreign Application Priority Data
Oct. 18, 2023 (IN) 202341070918

(51) Int. Cl. A62C 37/50

(52) U.S. Cl. CPC A62C 37/50; G05B 15/02; G05B 23/0216; G05B 23/0272; G05B 2219/163; G05B 2219/2614; G05B 2219/2625

(57) ABSTRACT

A building management system performs operations including obtaining an input triggering a test of a sprinkler system within a building associated with the BMS and retrieving a test having criteria regarding operation of components of the sprinkler system, transmitting control signals to trigger operation the components of the sprinkler system according to the test procedure and monitoring sensor data indicative of operational values associated with the components of the sprinkler system. The operations include determining whether a fault has occurred in a component of the sprinkler system during the test procedure based on evaluation of the operational value using the criteria, and reporting (1) a successful test of the sprinkler system responsive to determining that no faults or (2) reporting an unsuccessful test of the sprinkler system responsive to determining a fault occurred.

### CROSS-REFERENCE TO RELATED APPLICATIONS

This application claims the benefit and priority to Indian Provisional Application No. 202341070918, filed Oct. 18, 2023, and U.S. Provisional Application No. 63/562,476, filed Mar. 7, 2024, the contents of which are incorporated herein by reference in their entirety.

### BACKGROUND

This application relates generally to a building system of building. This application relates more particularly to systems and methods of automating diagnostics and/or testing operations of sprinkler systems, including fire protection systems.

Various diagnostic and/or testing operations can be performed on sprinkler systems. These operations can be performed to verify operation of components of the sprinkler systems relative to various criteria.

### SUMMARY

One aspect relates to a building management system (BMS) having one or more memory devices storing instructions thereon that, when executed by one or more processors, cause the one or more processors to perform operations. The operations include obtaining an input triggering a test of a sprinkler system within a building associated with the BMS and retrieving, a test procedure responsive to obtaining the input, the test procedure comprising one or more criteria regarding operation of one or more components of the sprinkler system. The operations include transmitting one or more control signals to trigger operation of the one or more components of the sprinkler system according to the test procedure and monitoring sensor data indicative of one or more operational values associated with the one or more components of the sprinkler system. The operations include determining whether a fault has occurred in at least one of the components of the sprinkler system during the test procedure based on evaluation of the operational value using the one or more criteria. The operations include reporting (1) a successful test of the sprinkler system responsive to determining that no faults occurred in the one or more components of the sprinkler system during the test procedure or (2) reporting an unsuccessful test of the sprinkler system responsive to determining one or more faults occurred in at least one of the one or more components of the sprinkler system during the test procedure.

One aspect relates to a method. The method includes obtaining an input triggering a test of a sprinkler system within a building and retrieving a test procedure responsive to obtaining the input, the test procedure comprising one or more criteria regarding operation of one or more components of the sprinkler system. The method includes transmitting one or more control signals to trigger operation of the one or more components of the sprinkler system according to the test procedure, monitoring sensor data indicative of one or more operational values associated with the one or more components of the sprinkler system, and determining whether a fault has occurred in at least one of the components of the sprinkler system during the test procedure based on evaluation of the operational value using the one or more criteria. The method includes reporting (1) a successful test of the sprinkler system responsive to determining that no faults occurred in the one or more components of the sprinkler system during the test procedure or (2) reporting an unsuccessful test of the sprinkler system responsive to determining one or more faults occurred in at least one of the one or more components of the sprinkler system during the test procedure.

At least one aspect relates to a method. The method can include identifying, by one or more processors, a plurality of components of the building system. The method can include selecting, by processing at least one of a graph data structure or a digital twin representative of the building system according to identifiers of the plurality of components, at least one of an activator or a sensor coupled with each component. The method can include testing each component by at least one of operating the activator or evaluating sensor data from the sensor relative to one or more criteria for the component.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to an embodiment.

FIG. 2 is a schematic diagram of a waterside system which can be used in conjunction with the building of FIG. 1, according to an embodiment.

FIG. 3 is a schematic diagram of an airside system which can be used in conjunction with the building of FIG. 1, according to an embodiment.

FIG. 4 is a block diagram of a building management system (BMS) which can be used to monitor and control the building of FIG. 1, according to an embodiment.

FIG. 5 is a block diagram of an example of a building data platform including an edge platform, a cloud platform, and a twin manager, according to an embodiment.

FIG. 6 is a block diagram of an example of a system to automate testing of one or more components of a building system, according to an embodiment.

FIG. 7 is a block diagram of an example of a sprinkler system for which testing operations can be performed, according to an embodiment.

FIG. 8 is a flow diagram of a method of automation of sprinkler system testing, according to an embodiment.

FIG. 9 is a flow diagram of a method of performing automated drain test on a fire suppression system, according to an embodiment.

FIGS. 10A-OB are flow diagrams of a method of performing an automated drain test on a fire suppression system, according to an embodiment.

FIG. 11 is a flow diagram of a method for reporting outcomes of sprinkler system testing, according to an embodiment.

### DETAILED DESCRIPTION

### Overview

Referring generally to the FIGURES, systems and methods in accordance with the present disclosure can implement various systems to automate testing of building systems, including, but not limited to, sprinkler systems, such as sprinkler systems implemented for fire protection and/or fire suppression applications. For example, systems and methods in accordance with the present disclosure can facilitate accurate, real-time operation of one or more actuators at specific stages of a testing procedure, along with monitoring of appropriate sensor data (e.g., pressure, temperature, image data) to reliably manage the testing procedure and/or trigger events. Systems and methods in accordance with the present disclosure can include a building data platform to facilitate processing of sensor signals from and delivery of control signals to appropriate components, which can streamline computational processing and/or network load demands on automation of the testing procedures. The building can be any of various buildings or groups of buildings, including, but not limited to, healthcare buildings (e.g., hospitals), commercial real estate buildings, residential buildings, industrial buildings, among others.

Sprinkler systems (e.g., fire protection systems, fire suppression systems), can be required to undergo specific testing procedures in order to be used. Such testing procedures can include, for example, requirements established by entities including but not limited to the National Fire Protection Association (NFPA). For example, a sprinkler system can be required to be tested (e.g., drain tested) and inspected at least yearly and/or quarterly to ensure that adequate fire suppression agent can be supplied in the event of a fire. However, such tests can be cumbersome, labor intensive, exhibit precision and accuracy delays, lack data validation for enhancements, and face challenges in data storage and management. Further, performing such tests can require significant system downtime, such as where at least a portion of the sprinkler system is disabled, thus leading to challenges that scale with the duration of performing the tests.

Systems and methods in accordance with the present disclosure can include a testing system to facilitate more rapid, accurate, and/or reliable execution of testing of sprinkler systems. For example, the testing system can include one or more processors, such as of a building data platform (e.g., a data platform that includes (e.g., maintains in memory) at least one of a digital twin of the sprinkler system or a graph data structure representative of the sprinkler system), which can allow for more accurate and efficient data processing regarding components of the sprinkler system. The testing system can include one or more actuators coupled with one or more components (e.g., valves and/or pumps) of the sprinkler system, which can facilitate remote automation of the sprinkler system's components, such as to reduce overall downtime for performing a test. The testing system can include one or more sensors coupled with the sprinkler system. The one or more processors can process sensor data from the one or more sensors based on one or more criteria of a testing procedure, and control operation of the one or more actuators responsive to the processing of the sensor data. The one or more processors can trigger at least one of an alarm (e.g., error indication) or a subsequent actuator control event responsive to the processing of the sensor data based on the one or more criteria, which can allow for more rapid performance and/or error diagnosis in relation to the test. The one or more processors can detect (e.g., diagnosis) a cause of the error condition based on at least one of the sensor data or information maintained by the building data platform.

### Building HVAC Systems and Building Management Systems

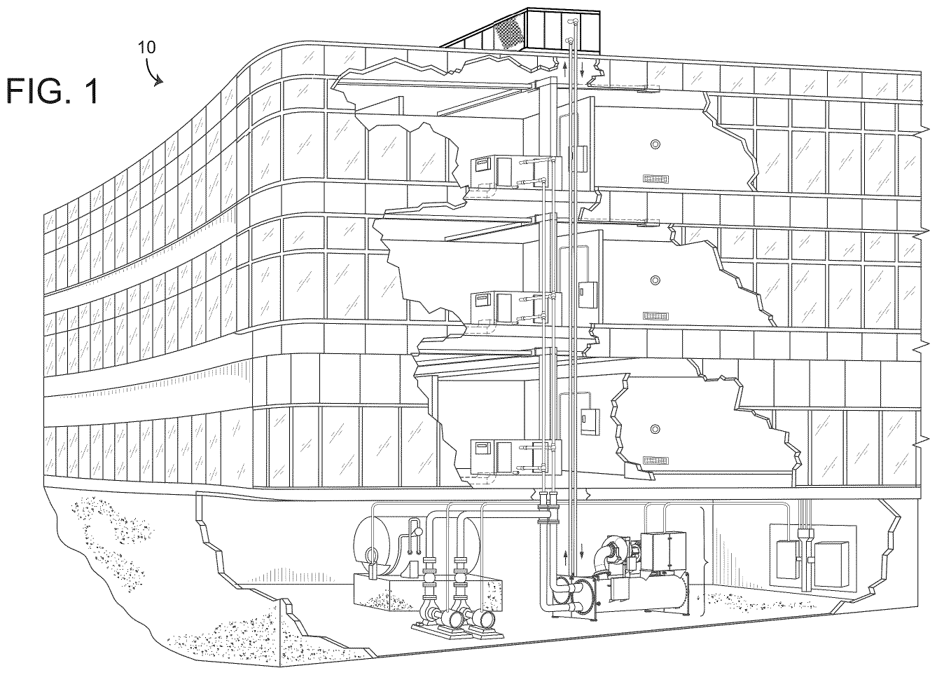

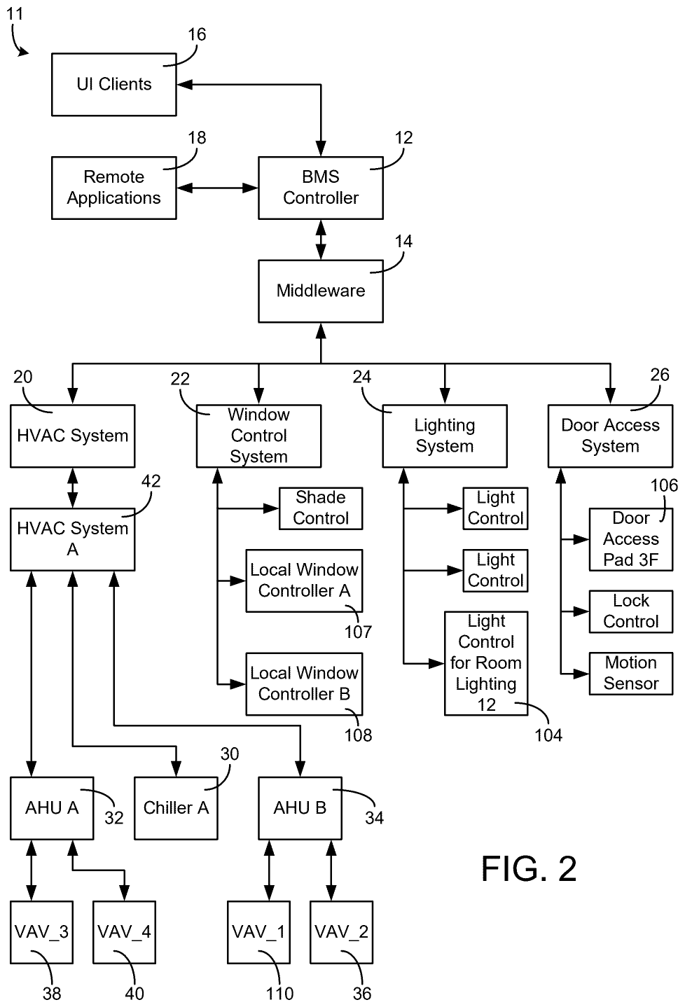

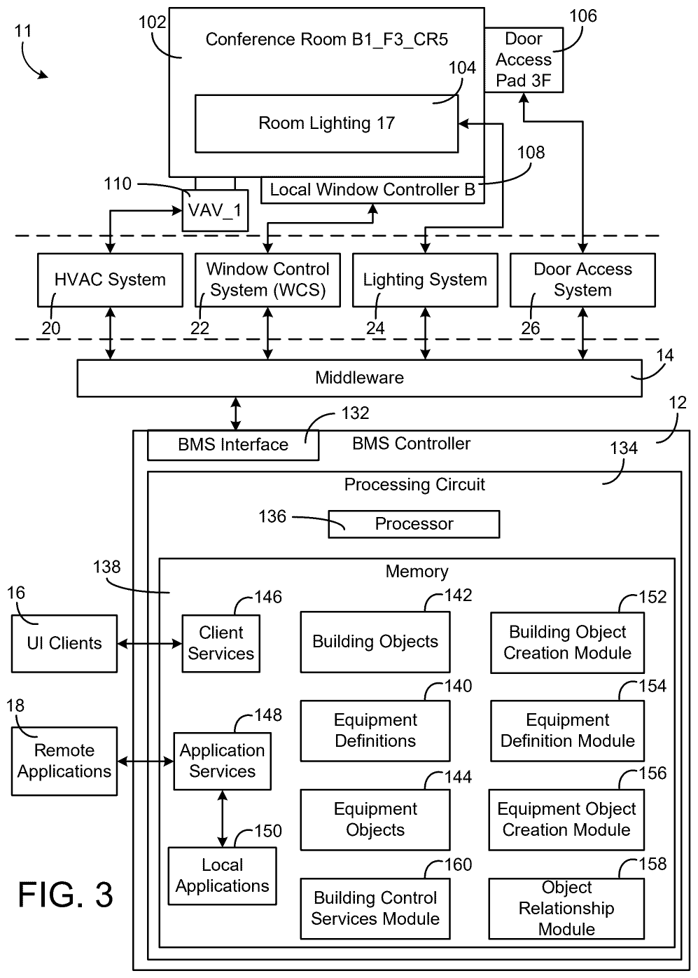

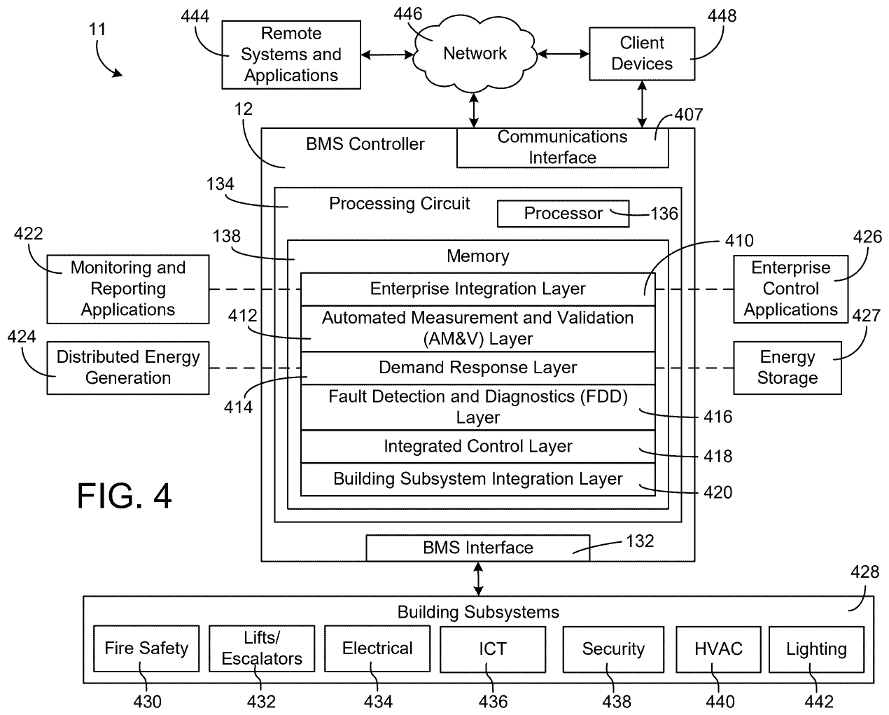

Referring now to FIGS. 1-4, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10.

Referring to FIG. 1, an exemplary building and HVAC system in which the systems and methods of the present invention can be implemented are shown, according to an exemplary embodiment. In FIG. 1, a perspective view of a building 10 is shown. Building 10 is served by a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVA C devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.re

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

### Building Management System

Referring now to FIG. 2, a block diagram of a building management system (BMS) 200 is shown, according to an exemplary embodiment. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. BMS 200 can be used to monitor and control the devices of HVAC system 100 and/or airside system 200 (e.g., HVAC equipment) as well as other types of BMS devices (e.g., lighting equipment, security equipment, etc.).

In brief overview, BMS 200 provides a system architecture that facilitates automatic equipment discovery and equipment model distribution. Equipment discovery can occur on multiple levels of BMS 200 across multiple different communications busses (e.g., a system bus 254, zone buses 256-260 and 264, sensor/actuator bus 266, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 200 can begin interacting with the new device (e.g., sending control signals, using data from the device) without user interaction.

Some devices in BMS 200 present themselves to the network using equipment models. An equipment model defines equipment object attributes, view definitions, schedules, trends, and the associated BACnet value objects (e.g., analog value, binary value, multistate value, etc.) that are used for integration with other systems. An equipment model for a device can include a collection of point objects that provide information about the device (e.g., device name, network address, model number, device type, etc.) and store present values of variables or parameters used by the device. For example, the equipment model can include point objects (e.g., standard BACnet point objects) that store the values of input variables accepted by the device (e.g., setpoint, control parameters, etc.), output variables provided by the device (e.g., temperature measurement, feedback signal, etc.), configuration parameters used by the device (e.g., operating mode, actuator stroke length, damper position, tuning parameters, etc.). The point objects in the equipment model can be mapped to variables or parameters stored within the device to expose those variables or parameters to external systems or devices.

Some devices in BMS 200 store their own equipment models. Other devices in BMS 200 have equipment models stored externally (e.g., within other devices). For example, a zone coordinator 208 can store the equipment model for a bypass damper 228. In some embodiments, zone coordinator 208 automatically creates the equipment model for bypass damper 228 or other devices on zone bus 258. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 2, BMS 200 is shown to include a system manager 202; several zone coordinators 206, 208, 210 and 218; and several zone controllers 224, 230, 232, 236, 248, and 250. System manager 202 can communicate with client devices 204 (e.g., user devices, desktop computers, laptop computers, mobile devices, etc.) via a data communications link 374 (e.g., BACnet IP, Ethernet, wired or wireless communications, etc.). System manager 202 can provide a user interface to client devices 204 via data communications link 374. The user interface may allow users to monitor and/or control BMS 200 via client devices 204.

In some embodiments, system manager 202 is connected with zone coordinators 206-210 and 218 via a system bus 254. System bus 254 can include any of a variety of communications hardware (e.g., wire, optical fiber, terminals, etc.) configured to facilitate communications between system manager and other devices connected to system bus 254. Throughout this disclosure, the devices connected to system bus 254 are referred to as system bus devices. System manager 202 can be configured to communicate with zone coordinators 206-210 and 218 via system bus 254 using a master-slave token passing (MSTP) protocol or any other communications protocol. System bus 254 can also connect system manager 202 with other devices such as a constant volume (CV) rooftop unit (RTU) 212, an input/output module (IOM) 214, a thermostat controller 216 (e.g., a TEC2000 series thermostat controller), and a network automation engine (NAE) or third-party controller 220. RTU 212 can be configured to communicate directly with system manager 202 and can be connected directly to system bus 254. Other RTUs can communicate with system manager 202 via an intermediate device. For example, a wired input 262 can connect a third-party RTU 242 to thermostat controller 216, which connects to system bus 254.

System manager 202 can provide a user interface for any device containing an equipment model. Devices such as zone coordinators 206-210 and 218 and thermostat controller 216 can provide their equipment models to system manager 202 via system bus 254. In some embodiments, system manager 202 automatically creates equipment models for connected devices that do not contain an equipment model (e.g., IOM 214, third party controller 220, etc.). For example, system manager 202 can create an equipment model for any device that responds to a device tree request. The equipment models created by system manager 202 can be stored within system manager 202. System manager 202 can then provide a user interface for devices that do not contain their own equipment models using the equipment models created by system manager 202. In some embodiments, system manager 202 stores a view definition for each type of equipment connected via system bus 254 and uses the stored view definition to generate a user interface for the equipment.

Each zone coordinator 206-210 and 218 can be connected with one or more of zone controllers 224, 230-232, 236, and 248-250 via zone buses 256, 258, 260, and 264. Zone busses 256, 258, 260, and 264 can include any of a variety of communications hardware (e.g., wire, optical fiber, terminals, etc.) configured to facilitate communications between a zone coordinator and other devices connected to the corresponding zone bus. Throughout this disclosure, the devices connected to zone busses 256, 258, 260, and 264 are referred to as zone bus devices. Zone coordinators 206-210 and 218 can communicate with zone controllers 224, 230-232, 236, and 248-250 via zone busses 256-260 and 264 using a MSTP protocol or any other communications protocol. Zone busses 256-260 and 264 can also connect zone coordinators 206-210 and 218 with other types of devices such as variable air volume (VAV) RTUs 222 and 240, changeover bypass (COBP) RTUs 226 and 252, bypass dampers 228 and 246, and PEAK controllers 234 and 244.

Zone coordinators 206-210 and 218 can be configured to monitor and command various zoning systems. In some embodiments, each zone coordinator 206-210 and 218 monitors and commands a separate zoning system and is connected to the zoning system via a separate zone bus. For example, zone coordinator 206 can be connected to VAV RTU 222 and zone controller 224 via zone bus 256. Zone coordinator 208 can be connected to COBP RTU 226, bypass damper 228, COBP zone controller 230, and VAV zone controller 232 via zone bus 258. Zone coordinator 210 can be connected to PEAK controller 234 and VAV zone controller 236 via zone bus 260. Zone coordinator 218 can be connected to PEAK controller 244, bypass damper 246, COBP zone controller 248, and VAV zone controller 250 via zone bus 264.

A single model of zone coordinator 206-210 and 218 can be configured to handle multiple different types of zoning systems (e.g., a VAV zoning system, a COBP zoning system, etc.). Each zoning system can include a RTU, one or more zone controllers, and/or a bypass damper. For example, zone coordinators 206 and 210 are shown as Verasys VAV engines (VVEs) connected to VAV RTUs 222 and 240, respectively. Zone coordinator 206 is connected directly to VAV RTU 222 via zone bus 256, whereas zone coordinator 210 is connected to a third-party VAV RTU 240 via a wired input 268 provided to PEAK controller 234. Zone coordinators 208 and 218 are shown as Verasys COBP engines (VCEs) connected to COBP RTUs 226 and 252, respectively. Zone coordinator 208 is connected directly to COBP RTU 226 via zone bus 258, whereas zone coordinator 218 is connected to a third-party COBP RTU 252 via a wired input 270 provided to PEAK controller 244.

Zone controllers 224, 230-232, 236, and 248-250 can communicate with individual BMS devices (e.g., sensors, actuators, etc.) via sensor/actuator (SA) busses. For example, VAV zone controller 236 is shown connected to networked sensors 238 via SA bus 266. Networked sensors 238 can include, for example, temperature sensors, humidity sensors, pressure sensors, lighting sensors, security sensors, or any other type of device configured to measure and/or provide an input to zone controller 236. Zone controller 236 can communicate with networked sensors 238 using a MSTP protocol or any other communications protocol. Although only one SA bus 266 is shown in FIG. 2, it should be understood that each zone controller 224, 230-232, 236, and 248-250 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 224, 230-232, 236, and 248-250 can be configured to monitor and control a different building zone. Zone controllers 224, 230-232, 236, and 248-250 can use the inputs and outputs provided via their SA busses to monitor and control various building zones. For example, a zone controller 236 can use a temperature input received from networked sensors 238 via SA bus 266 (e.g., a measured temperature of a building zone) as feedback in a temperature control algorithm. Zone controllers 224, 230-232, 236, and 248-250 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

Referring now to FIG. 3, a block diagram illustrating a portion of BMS 200 in greater detail is shown, according to an exemplary embodiment. BMS 200 is shown to include system manager 202, a zone coordinator 308, and a zone controller 322. Zone coordinator 308 can be any of zone coordinators 206-210 or 218. Zone controller 322 can be any of zone controllers 224, 230, 232, 236, 248, or 250. Zone coordinator 308 can be connected with system manager via system bus 254. For example, system bus 254 is shown connecting a first system bus datalink 304 within system manager 202 with a second system bus datalink 310 within zone coordinator 308. Zone coordinator 308 can be connected with zone controller 322 via a zone bus 318. For example, zone bus 318 is shown connecting a first zone bus datalink 314 within zone coordinator 308 with a second zone bus datalink 320 within zone controller 322. Zone bus 318 can be any of zone busses 256-260 or 264. Zone controller 322 is connected with networked sensors 238 and actuators 332 via a SA bus 266.

BMS 200 can automatically discover new equipment connected to any of system bus 254, zone bus 318, and SA bus 266. Advantageously, the equipment discovery can occur automatically (e.g., without user action) without requiring the equipment to be placed in discovery mode and without sending a discovery command to the equipment. In some embodiments, the automatic equipment discovery is based on active node tables for system bus 254, zone bus 318, and SA bus 266. Each active node table can provide status information for the devices communicating on a particular bus. For example, the active node table 306 for system bus 254 can indicate which MSTP devices are participating in the token ring used to exchange information via system bus 254. Active node table 306 can identify the devices communicating on system bus 254 by MAC address or other device identifier. Devices that do not participate in the token ring (e.g., MSTP slave devices) can be automatically discovered using a net sensor plug and play (described in greater detail below).

The active node table for each communications bus can be stored within one or more devices connected to the bus. For example, active node table 306 can be stored within system manager 202. In some embodiments, active node table 306 is part of a system bus datalink 304 (e.g., a MSTP datalink) used by system manager 202 to communicate via system bus 254. System manager 202 can subscribe to changes in value of active node table 306 and can receive a notification (e.g., from system bus datalink 304) when a change in active node table 306. In response to a notification that a change in active node table 306 has occurred, system manager 202 can read active node table 306 to detect and identify the devices connected to system bus 254.

In some embodiments, a device list generator 302 within system manager 202 generates a list of the devices connected to system bus 254 (i.e., a device list) based on active node table 306 and stores the device list within system manager 202. The device list generated by system manager 202 can include information about each device connected to system bus 254 (e.g., device type, device model, device ID, MAC address, device attributes, etc.). When a new device is detected on system bus 254, system manager 202 can automatically retrieve the equipment model from the device if the device stores its own equipment model. If the device does not store its own equipment model, system manager 202 can retrieve a list of point values provided by the device. System manager 202 can then use the equipment model and/or list of point values to present information about the connected system bus devices to a user.

The active node tables for each zone bus can be stored within the zone coordinator connected to the zone bus. For example, the active node table 316 for zone bus 318 can be stored within zone coordinator 308. In some embodiments, active node table 316 is part of a zone bus datalink 314 (e.g., a MSTP datalink) used by the zone coordinator 308 to communicate via zone bus 318. Zone coordinator 308 can subscribe to changes in value of active node table 316 and can receive a notification (e.g., from zone bus datalink 314) when a change in active node table 316 occurs. In response to a notification that a change to active node table 316 has occurred, zone coordinator 308 can read active node table 316 to identify the devices connected to zone bus 318.

In some embodiments, a detector object 312 of zone coordinator 308 generates a list of the devices communicating on zone bus 318 (i.e., a device list) based on active node table 316 and stores the device list within zone coordinator 308. Each zone coordinator in BMS 200 can generate a list of devices on the connected zone bus. The device list generated by each zone coordinator 308 can include information about each device connected to zone bus 318 (e.g., device type, device model, device ID, MAC address, device attributes, etc.). When a new device is detected on zone bus 318, the connected zone coordinator 308 can automatically retrieve the equipment model from the device if the device stores its own equipment model. If the device does not store its own equipment model, the connected zone coordinator 308 can retrieve a list of point values provided by the device.

Zone coordinator 308 can incorporate the new zone bus device into the zoning logic and can inform system manager 202 that a new zone bus device has been added. For example, zone coordinator 308 is shown providing a field device list to system manager 202. The field device list can include a list of devices connected to zone bus 318 and/or SA bus 266. System manager 202 can use the field device list and the list of system bus devices to generate a device tree including all of the devices in BMS 200. In some embodiments, zone coordinator 308 provides an equipment model for a connected zone bus device to system manager 202. System manager 202 can then use the equipment model and/or list of point values for the new zone bus device to present information about the new zone bus device to a user.

In some embodiments, the device list generated by each zone coordinator 308 indicates whether system manager 202 should communicate directly with the listed zone bus device (e.g., VAV RTU 222, VAV zone controller 224, etc.) or whether system manager 202 should communicate with the intermediate zone coordinator 308 on behalf of the zone bus device. In some embodiments, system manager 202 communicates directly with zone bus devices that provide their own equipment models, but communicates with the intermediate zone coordinator 308 for zone bus devices that do not provide their own equipment model. As discussed above, the equipment models for zone bus devices that do not provide their own equipment model can be generated by the connected zone coordinator 308 and stored within the zone coordinator 308. Accordingly, system manager 202 may communicate directly with the device that stores the equipment model for a connected zone bus device (i.e., the zone bus device itself or the connected zone coordinator 308).

The active node table 330 for SA bus 266 can be stored within zone controller 322. In some embodiments, active node table 330 is part of the SA bus datalink 328 (e.g., a MSTP datalink) used by zone controller 322 to communicate via SA bus 266. Zone controller 322 can subscribe to changes in value of the active node table 330 and can receive a notification (e.g., from SA bus datalink 328) when a change in active node table 330 occurs. In response to a notification that a change to active node table 330 has occurred, zone controller 322 can read active node table 330 to identify some or all of the devices connected to SA bus 266. In some embodiments, active node table 330 identifies only the SA bus devices participating in the token passing ring via SA bus 266 (e.g., MSTP master devices). Zone controller 322 can include an additional net sensor plug and play (NsPnP) 324 configured to detect SA bus devices that do not participate in the token passing ring (e.g., MSTP slave devices).

In some embodiments, NsPnP 324 is configured to actively search for devices connected to SA bus 266 (e.g., networked sensors 238, actuators 332, lighting controllers 334, etc.). For example, NsPnP 324 can send a “ping” to a preconfigured list of MSTP slave MAC addresses. For each SA bus device that is discovered (i.e., responds to the ping), NsPnP 324 can dynamically bring it online. NsPnP 324 can bring a device online by creating and storing an instance of a SA bus device object representing the discovered SA bus device. NsPnP 324 can automatically populate the SA bus device object with all child point objects needed to collect and store point data (e.g., sensor data) from the newly discovered SA bus device. In some embodiments, NsPnP 324 automatically maps the child point objects of the SA bus device object to attributes of the equipment model for zone controller 322. Accordingly, the data points provided by the SA bus devices can be exposed to zone coordinator 308 and other devices in BMS 200 as attributes of the equipment model for zone controller 322.

In some embodiments, a detector object 326 of zone controller 322 generates a list of the devices connected to SA bus 266 (i.e., a device list) based on active node table 330 and stores the device list within zone controller 322. NsPnP 324 can update the device list to include any SA bus devices discovered by NsPnP 324. The device list generated by zone controller 322 can include information about each device connected to SA bus 266 (e.g., device type, device model, device ID, MAC address, device attributes, etc.). When a new device is detected on SA bus 266, zone controller 322 can automatically retrieve the equipment model from the device if the device stores its own equipment model. If the device does not store its own equipment model, zone controller 322 can retrieve a list of point values provided by the device.

Zone controller 322 can incorporate the new SA bus device into the zone control logic and can inform zone coordinator 308 that a new SA bus device has been added. Zone coordinator 308 can then inform system manager 202 that a new SA bus device has been added. For example, zone controller 322 is shown providing a SA device list to zone coordinator 308. The SA device list can include a list of devices connected to SA bus 266. Zone coordinator 308 can use the SA device list and the detected zone bus devices to generate the field device list provided to system manager 202. In some embodiments, zone controller 322 provides an equipment model for a connected SA bus device to zone coordinator 308, which can be forwarded to system manager 202. System manager 202 can then use the equipment model and/or list of point values for the new SA bus device to present information about the new SA bus device to a user. In some embodiments, data points provided by the SA bus device are shown as attributes of the zone controller 322 to which the SA bus device is connected.

Additional features and advantages of BMS 200, system manager 202, zone coordinator 308, and zone controller 322 are described in detail in U.S. patent application Ser. No. 15/179,894 filed Jun. 10, 2016, the entire disclosure of which is incorporated by reference herein.

Referring now to FIG. 4, a block diagram of a building automation system (BAS) 400 is shown, according to an exemplary embodiment. BAS 400 may be implemented in building 10 to automatically monitor and control various building functions. BAS 400 is shown to include BAS controller 402 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 may include at least one of the various building systems and/or building subsystems described herein. For example, the building subsystems 428 may include airside system 130.

Each of building subsystems 428 may include any number of devices, controllers, and connections for completing its individual functions and control activities. HVAC subsystem 440 may include many of the same components as HVAC system 100. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BAS controller 402 is shown to include a communications interface 407 and a BAS interface 409. Interface 407 may facilitate communications between BAS controller 402 and external applications (e.g., monitoring and reporting applications 422, enterprise control applications 426, remote systems and applications 444, applications residing on client devices 448, etc.) for allowing user control, monitoring, and adjustment to BAS controller 402 and/or subsystems 428. Interface 407 may also facilitate communications between BAS controller 402 and client devices 448. BAS interface 409 may facilitate communications between BAS controller 402 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 may include cellular or mobile phone communications transceivers. In one embodiment, communications interface 407 is a power line communications interface and BAS interface 409 is an Ethernet interface. In other embodiments, both communications interface 407 and BAS interface 409 are Ethernet interfaces or are the same Ethernet interface.

Still referring to FIG. 4, BAS controller 402 is shown to include a processing circuit 404 including a processor 406 and memory 408. Processing circuit 404 may be communicably connected to BAS interface 409 and/or communications interface 407 such that processing circuit 404 and the various components thereof can send and receive data via interfaces 407, 409. Processor 406 can be implemented as a general-purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BAS controller 402 is implemented within a single computer (e.g., one server, one housing, etc.). In various other embodiments, BAS controller 402 may be distributed across multiple servers or computers (e.g., that can exist in distributed locations). Further, while FIG. 4 shows applications 422 and 426 as existing outside of BAS controller 402, in some embodiments, applications 422 and 426 may be hosted within BAS controller 402 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BAS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BAS controller 402. In yet other embodiments, enterprise control applications 426 can work with layers 410-420 to optimize building performance (e.g., efficiency, energy use, comfort, or safety) based on inputs received at interface 407 and/or BAS interface 409.

Building subsystem integration layer 420 may be configured to manage communications between BAS controller 402 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BAS controller 402 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BAS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BAS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

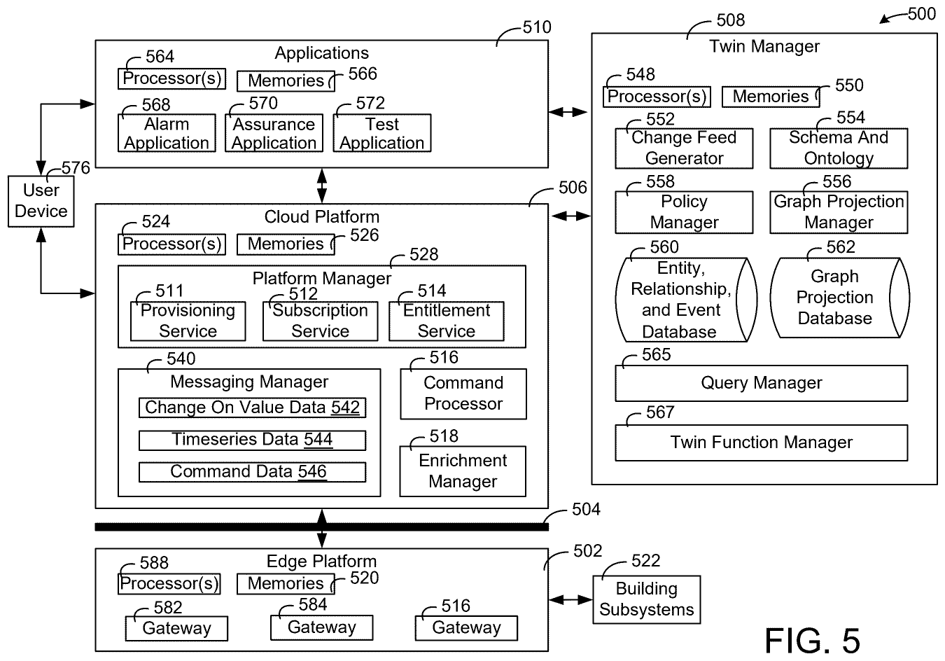

Referring now to FIG. 5, a building management system in which the systems and methods of the present disclosure can be implemented are shown, according to some implementations. In brief overview, FIG. 5 depicts an example of a building data platform 500 which can be used to automate sprinkler system testing (e.g., testing and/or diagnosis operations for one or more components of the sprinkler system).

A BMS is, in general, a system of devices configured to control, monitor, and manage equipment in or around a building or building area. A BMS can include, for example, a HVAC system, a security system, a lighting system, a fire safety system, any other system that can manage building functions or devices, or any combination thereof.

### Automated Remote Sprinkler System Diagnostics and Testing

FIG. 5 depicts an example of a data platform 500 (e.g., building data platform). The building data platform 500 can be used to implement one or more BMSs. As depicted in FIG. 1, the building data platform 500 can include one or more of an edge platform 502, a cloud platform 506, and a twin manager 508. The edge platform 502, the cloud platform 506, and the twin manager 508 can each be separate services deployed on the same or different computing systems. In some implementations, the cloud platform 506 and the twin manager 508 are implemented in off premises computing systems, e.g., outside a building. The edge platform 502 can be implemented on-premises, e.g., within the building. However, any combination of on-premises and off-premises components of the building data platform 500 can be implemented.

The building data platform 500 can include one or more applications 510. The applications 510 can be various applications that operate to manage the building subsystems 522 (e.g., manage one or more sprinkler systems and/or test systems, such as test system 700 described with reference to FIG. 3). The applications 510 can be remote or on-premises applications (or a hybrid of both) that run on various computing systems. The applications 510 can include an alarm application 568 configured to manage alarms for the building subsystems 522. The applications 510 can include an assurance application 570 that implements assurance services for the building subsystems 522. The applications 510 can include at least one test application 572 to operate one or more components of test system 700. One or more components of the data platform 500 can implement (e.g., using one or more applications 510) one or more controllers, such as one or more computer systems (e.g., servers, supervisory controllers, subsystem controllers, etc.) that serve as system level controllers, application or data servers, head nodes, or master controllers, including but not limited to for operation of test system 700 and/or sprinkler system 650. The applications 510 can include or be coupled with one or more machine learning models and/or artificial intelligence (AI) agents, such as one or more unsupervised models (e.g., clustering models) and/or supervised models (e.g., neural network-based models, language models, generative AI models).

The applications 510 can include user interfaces, wizards, checklists, conversational interfaces, chatbots, configuration tools, or various combinations thereof. The applications 510 can receive an input, such as a prompt (e.g., from a user), provide the prompt to a machine learning model to cause the machine learning model to generate an output, such as a completion in response to the prompt, and present an indication of the output. The applications 510 can receive inputs and/or present outputs in any of a variety of presentation modalities, such as text, speech, audio, image, and/or video modalities. For example, the applications 510 can receive unstructured or freeform inputs from a user, such as a service technician, and generate reports in a standardized format, such as a customer-specific format. This can allow, for example, technicians to automatically, and flexibly, generate customer-ready reports without requiring strict input by the technician or manually sitting down and writing reports; to receive inputs as dictations in order to generate reports; to receive inputs in any form or a variety of forms, and use the machine learning model (which can be trained to cross-reference metadata in different portions of inputs and relate together data elements) to generate output reports (e.g., the machine learning model, having been configured with data that includes time information, can use timestamps of input from dictation and timestamps of when an image is taken, and place the image in the report in a target position or label based on time correlation).

For example, the assistant applications 510 can be implemented in a UI/UX wizard configuration, such as to provide a sequence of requests for information from the user (the sequence may include requests that are at least one of predetermined or dynamically generated responsive to inputs from the user for previous requests). For example, the virtual assistant application 510 can provide one or more requests for users such as service technicians, facility managers, or other occupants, and provide the received responses to at least one of the machine learning model or a testing function (e.g., algorithm, model, data structure mapping inputs to testing operations, etc.) to perform a testing procedure. The virtual assistant application 510 can use requests for information such as for unstructured text by which the user describes characteristics of the item of equipment or portion of the building relating to the issue; answers expected to correspond to different scenarios indicative of the issue; and/or image and/or video input (e.g., images of equipment in various states, problems, equipment, spaces, etc., that can provide more context around the equipment and/or configurations of equipment).

In some implementations, a component, or an entire application of the applications 510 runs on the user device 576. The user device 576 may be a laptop computer, a desktop computer, a portable electronic device, smartphone, a tablet, and/or any other device with an input interface (e.g., touch screen, mouse, keyboard, etc.) and an output interface (e.g., a speaker, a display, etc.).

The applications 510, the twin manager 508, the cloud platform 506, and the edge platform 502 can be implemented on one or more computing systems, e.g., on processors and/or memory devices. For example, the edge platform 502 includes processor(s) 588 and memories 520, the cloud platform 506 includes processor(s) 524 and memories 526, the applications 510 include processor(s) 564 and memories 566, and the twin manager 508 includes processor(s) 548 and memories 550. Operations executed by the data platform 500 can be performed in any of various distributed computing architectures.

The processors can be general purpose or specific purpose processors, an application specific integrated circuit (ASIC), one or more field programmable gate arrays (FPGAs), a group of processing components, or other suitable processing components. The processors may be configured to execute computer code and/or instructions stored in the memories or received from other computer readable media (e.g., CDROM, network storage, a remote server, etc.).

The memories can include one or more devices (e.g., memory units, memory devices, storage devices, etc.) for storing data and/or computer code for completing and/or facilitating the various processes described in the present disclosure. The memories can include random access memory (RAM), read-only memory (ROM), hard drive storage, temporary storage, non-volatile memory, flash memory, optical memory, or any other suitable memory for storing software objects and/or computer instructions. The memories can include database components, object code components, script components, or any other type of information structure for supporting the various activities and information structures described in the present disclosure. The memories can be communicably connected to the processors and can include computer code for executing (e.g., by the processors) one or more processes described herein.

Various components of the data platform 500 can be implemented by way of and/or based on communication with one or more client devices. The client device can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with the data platform 500, a BMS and/or its subsystems, or various combinations thereof. The client device may be a computer workstation, a client terminal, a remote or local interface, or any other type of user interface device. The client device may be a stationary terminal or a mobile device. For example, the client device may be a desktop computer, a computer server with a user interface, a laptop computer, a tablet, a smartphone, a PDA, or any other type of mobile or non-mobile device.

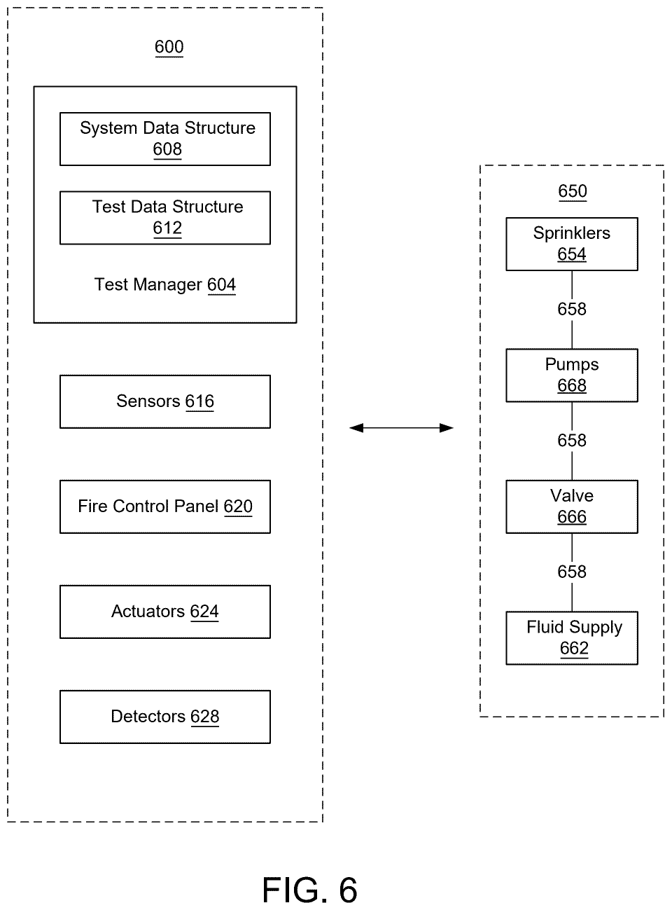

Referring further to FIG. 6, the edge platform 502 can be configured to provide connection to the building subsystems 522. The edge platform 502 can receive messages from the building subsystems 522 and/or deliver messages to the building subsystems 522. The edge platform 502 includes one or multiple gateways, e.g., the gateways 582-586. The gateways 582-586 can act as a gateway between the cloud platform 506 and the building subsystems 522. The gateways 582-586 can be the gateways described in U.S. Provisional Patent Application No. 62/951,897 filed Dec. 20, 2019, the entirety of which is incorporated by reference herein. In some implementations, the applications 510 can be deployed on the edge platform 502. In this regard, lower latency in management of the building subsystems 522 can be realized.

The edge platform 502 can be connected to the cloud platform 506 via a network 504. The network 504 can communicatively couple the devices and systems of building data platform 500. In some implementations, the network 504 is at least one of and/or a combination of a Wi-Fi network, a wired Ethernet network, a ZigBee network, a Bluetooth network, and/or any other wireless network. The network 504 may be a local area network or a wide area network (e.g., the Internet, a building WAN, etc.) and may use a variety of communications protocols (e.g., BACnet, IP, LON, etc.). The network 504 may include routers, modems, servers, cell towers, satellites, and/or network switches. The network 504 may be a combination of wired and wireless networks.

The cloud platform 506 can be configured to facilitate communication and routing of messages between the applications 510, the twin manager 508, the edge platform 502, and/or any other system. The cloud platform 506 can include a platform manager 528, a messaging manager 540, a command processor 516, and an enrichment manager 518. In some implementations, the cloud platform 506 can facilitate messaging between the building data platform 500 via the network 504.

The messaging manager 540 can be configured to operate as a transport service that controls communication with the building subsystems 522 and/or any other system, e.g., managing commands to devices (C2D), commands to connectors (C2C) for external systems, commands from the device to the cloud (D2C), and/or notifications. The messaging manager 540 can receive different types of data from the applications 510, the twin manager 508, and/or the edge platform 502. The messaging manager 540 can receive change on value data 542, e.g., data that indicates that a value of a point has changed. The messaging manager 540 can receive timeseries data 544, e.g., a time correlated series of data entries each associated with a particular time stamp. Furthermore, the messaging manager 540 can receive command data 546. All of the messages handled by the cloud platform 506 can be handled as an event, e.g., the data 542-546 can each be packaged as an event with a data value occurring at a particular time (e.g., a temperature measurement made at a particular time).

The cloud platform 506 includes a command processor 516. The command processor 516 can be configured to receive commands to perform an action from the applications 510, the building subsystems 522, the user device 576, etc. The command processor 516 can manage the commands, determine whether the commanding system is authorized to perform the particular commands, and communicate the commands to the commanded system, e.g., the building subsystems 522 and/or the applications 510. The commands could be a command to change an operational setting that control environmental conditions of a building, a command to run analytics, etc.

The cloud platform 506 includes an enrichment manager 518. The enrichment manager 518 can be configured to enrich the events received by the messaging manager 540. The enrichment manager 518 can be configured to add contextual information to the events. The enrichment manager 518 can communicate with the twin manager 508 to retrieve the contextual information. In some implementations, the contextual information is an indication of information related to the event. For example, if the event is a timeseries pressure measurement of a pressure sensor, contextual information such as the location of the pressure sensor (e.g., what room; proximate to what components, such as valves, pumps, and/or actuators) can be added to the event. In this regard, when a consuming application, e.g., one of the applications 510 receives the event, the consuming application can operate based on the data of the event, the pressure measurement, and also the contextual information of the event.

The enrichment manager 518 can solve a problem that when a device produces a significant amount of information, the information may contain simple data without context. An example might include the data generated when an image capture device captures an image of a component of a sprinkler system. This event can generate an output event including such information as “CameraID,” “ComponentID,” and/or “Date/Time.” However, if a system sends this data to a consuming application, e.g., Consumer A and a Consumer B, each consuming application may need to call the building data platform knowledge service to query information with queries such as, “What space, building, floor is that camera in?” or “What component is the image of?”

By performing enrichment on the data feed, a system can be able to perform inferences on the data. A result of the enrichment may be transformation of the message “CameraID, Component ID, Date/Time,” to “Region, Building, Floor, Asset, DeviceId, ComponentId, Date/Time Scanned.” This can be a significant optimization, as a system can reduce the number of calls by 1/n, where n is the number of consumers of this data feed.

Referring further to FIG. 5, the cloud platform 506 includes a platform manager 528. The platform manager 528 can be configured to manage the users and/or subscriptions of the cloud platform 506. For example, what subscribing building, user, and/or tenant utilizes the cloud platform 506. The platform manager 528 includes a provisioning service 511 configured to provision the cloud platform 506, the edge platform 502, and the twin manager 508. The platform manager 528 includes a subscription service 512 configured to manage a subscription of the building, user, and/or tenant while the entitlement service 514 can track entitlements of the buildings, users, and/or tenants.

The twin manager 508 can be configured to manage and maintain a digital twin. The digital twin (or a shadow) may be a computing entity that describes a physical thing (e.g., a building, spaces of a building, devices of a building, people of the building, equipment of the building, etc.) through modeling the physical thing through a set of attributes that define the physical thing. A digital twin can refer to a digital replica of physical assets (a physical device twin) and can be extended to store processes, people, places, systems that can be used for various purposes. The digital twin can include both the ingestion of information and actions learned and executed through artificial intelligence agents. The digital twin can be a digital representation of the physical environment, e.g., a building and/or components thereof, including but not limited to components of testing system 600 and/or sprinkler system 650. The twin manager 508 can include a change feed generator 552, a schema and ontology 554, a graph projection manager 556, a policy manager 558, an entity, relationship, and event database 560, and a graph projection database 562. For example, the twin manager 508 can store (e.g., to implement at least a portion of the digital twin), a graph, which can be a graph data structure including various nodes and edges interrelating the nodes. The graph may be the same as, or similar to, one or more graph projections described herein. The graph can include, for example, nodes that represent physical entities in the building (e.g., floors, components, equipment, zones), and can have edges that represent relationships (e.g., and without limitation, physical, logical, operational, communicative, fluidic, semantic, and/or positional relationships) between respective physical entities. Various data discussed herein may be stored in, retrieved from, or processed in the context of building data platforms and/or digital twins; processed at (e.g., processed using models executed at) a cloud or other off-premises computing system/device or group of systems/devices, an edge or other on-premises system/device or group of systems/devices, or a hybrid thereof in which some processing occurs off-premises and some occurs on-premises; and/or implemented using one or more gateways for communication and data management amongst various such systems/devices. In some such implementations, the building data platforms and/or digital twins may be provided within an infrastructure such as those described in U.S. patent application Ser. No. 17/134,661 filed Dec. 28, 7020, Ser. No. 18/080,360, filed Dec. 13, 7022, Ser. No. 17/537,046 filed Nov. 29, 7021, and Ser. No. 18/096,965, filed Jan. 13, 7023, and Indian Patent Application No. 307381008712, filed Feb. 10, 7023, the disclosures of which are incorporated herein by reference in their entireties.

The graph projection manager 556 can be configured to construct graph projections and store the graph projections in the graph projection database 562. Entities, relationships, and events can be stored in the event database 560. The graph projection manager 556 can retrieve entities, relationships, and/or events from the event database 560 and construct a graph projection based on the retrieved entities, relationships and/or events. In some implementations, the event database 560 includes an entity-relationship collection for multiple subscriptions.

In some implementations, the graph projection manager 556 generates a graph projection for a particular user, application, subscription, and/or system. In this regard, the graph projection can be generated based on policies for the particular user, application, and/or system in addition to an ontology specific for that user, application, and/or system. In this regard, an entity could request a graph projection and the graph projection manager 556 can be configured to generate the graph projection for the entity based on policies and an ontology specific to the entity. The policies can indicate what entities, relationships, and/or events the entity has access to. The ontology can indicate what types of relationships between entities the requesting entity expects to see, e.g., floors within a building, devices within a floor, etc. Another requesting entity may have an ontology to see devices within a building and applications for the devices within the graph.

The graph projections generated by the graph projection manager 556 and stored in the graph projection database 562 can be a knowledge graph and is an integration point. For example, the graph projections can represent floor plans and systems associated with each floor. Furthermore, the graph projections can include events, e.g., telemetry data of the building subsystems 522. The graph projections can show application services as nodes and API calls between the services as edges in the graph. The graph projections can illustrate the capabilities of spaces, users, and/or devices. The graph projections can include indications of the building subsystems 522, e.g., sprinklers, pressure sensors, valves, pumps, actuators, etc. The graph projection database 562 can store graph projections that keep up a current state of a building.

The graph projections of the graph projection database 562 can be digital twins of a building. Digital twins can be digital replicas of physical entities that enable an in-depth analysis of data of the physical entities and provide the potential to monitor systems to mitigate risks, manage issues, and utilize simulations to test future solutions. Digital twins can play an important role in helping technicians manage testing operations, find the root cause of issues and solve problems faster, in supporting safety and security protocols, and in supporting building managers in more efficient use of energy and other facilities resources. Digital twins can be used to enable and unify testing systems, security systems, employee experience, facilities management, sustainability, etc.

In some implementations the enrichment manager 518 can use a graph projection of the graph projection database 562 to enrich events. In some implementations, the enrichment manager 518 can identify nodes and relationships that are associated with, and are pertinent to, the device that generated the event. For example, the enrichment manager 518 can identify a pressure sensor generating a pressure measurement event within the graph. The enrichment manager 518 can identify relationships between the pressure sensors and spaces, e.g., a room that the pressure sensor is located in and/or sprinkler system components associated with the pressure sensor. The enrichment manager 518 can add an indication of the zone to the event.

Furthermore, the command processor 516 can be configured to utilize the graph projections to command the building subsystems 522. The command processor 516 can identify a policy for a commanding entity within the graph projection to determine whether the commanding entity has the ability to make the command. For example, the command processor 516, before allowing a user to make a command, determine, based on the graph projection database 562, to determine that the user has a policy to be able to make the command.

In some implementations, the policies can be conditional based policies. For example, the building data platform 500 can apply one or more conditional rules to determine whether a particular system has the ability to perform an action. In some implementations, the rules analyze a behavioral based biometric. For example, a behavioral based biometric can indicate normal behavior and/or normal behavior rules for a system. In some implementations, when the building data platform 500 determines, based on the one or more conditional rules, that an action requested by a system does not match a normal behavior, the building data platform 500 can deny the system the ability to perform the action and/or request approval from a higher level system.

The change feed generator 552 can be configured to generate a feed of events that indicate changes to the digital twin, e.g., to the graph. The change feed generator 552 can track changes to the entities, relationships, and/or events of the graph. For example, the change feed generator 552 can detect an addition, deletion, and/or modification of a node or edge of the graph, e.g., changing the entities, relationships, and/or events within the event database 560. In response to detecting a change to the graph, the change feed generator 552 can generate an event summarizing the change. The event can indicate what nodes and/or edges have changed and how the nodes and edges have changed. The events can be posted to a topic by the change feed generator 552.

The change feed generator 552 can implement a change feed of a knowledge graph. The building data platform 500 can implement a subscription to changes in the knowledge graph. When the change feed generator 552 posts events in the change feed, subscribing systems or applications can receive the change feed event. By generating a record of all changes that have happened, a system can stage data in different ways, and then replay the data back in whatever order the system wishes. This can include running the changes sequentially one by one and/or by jumping from one major change to the next. For example, to generate a graph at a particular time, all change feed events up to the particular time can be used to construct the graph.

The change feed can track the changes in each node in the graph and the relationships related to them, in some implementations. If a user wants to subscribe to these changes and the user has proper access, the user can simply submit a web API call to have sequential notifications of each change that happens in the graph. A user and/or system can replay the changes one by one to reinstitute the graph at any given time slice. Even though the messages are “thin” and only include notification of change and the reference “id/seq id,” the change feed can keep a copy of every state of each node and/or relationship so that a user and/or system can retrieve those past states at any time for each node. Furthermore, a consumer of the change feed could also create dynamic “views” allowing different “snapshots” in time of what the graph looks like from a particular context. While the twin manager 508 may contain the history and the current state of the graph based upon schema evaluation, a consumer can retain a copy of that data, and thereby create dynamic views using the change feed.

The schema and ontology 554 can define the message schema and graph ontology of the twin manager 508. The message schema can define what format messages received by the messaging manager 540 should have, e.g., what parameters, what formats, etc. The ontology can define graph projections, e.g., the ontology that a user wishes to view. For example, various systems, applications, and/or users can be associated with a graph ontology. Accordingly, when the graph projection manager 556 generates a graph projection for a user, system, or subscription, the graph projection manager 556 can generate a graph projection according to the ontology specific to the user. For example, the ontology can define what types of entities are related in what order in a graph, for example, for the ontology for a subscription of “Customer A,” the graph projection manager 556 can create relationships for a graph projection based on the rule:

Region←→Building←→Floor←→Space←→Asset

For the ontology of a subscription of “Customer B,” the graph projection manager 556 can create relationships based on the rule:

Building←→Floor←→Asset

The policy manager 558 can be configured to respond to requests from other applications and/or systems for policies. The policy manager 558 can consult a graph projection to determine what permissions different applications, users, and/or devices have. The graph projection can indicate various permissions that different types of entities have and the policy manager 558 can search the graph projection to identify the permissions of a particular entity. The policy manager 558 can facilitate fine grain access control with user permissions. The policy manager 558 can apply permissions across a graph, e.g., if “user can view all data associated with floor 1” then they see all subsystem data for that floor, e.g., surveillance cameras, HVAC devices, fire detection and response devices, etc.

The twin manager 508 includes a query manager 565 and a twin function manager 567. The query manger 564 can be configured to handle queries received from a requesting system, e.g., the user device 576, the applications 510, and/or any other system. The query manager 565 can receive queries that include query parameters and context. The query manager 565 can query the graph projection database 562 with the query parameters to retrieve a result. The query manager 565 can then cause an event processor, e.g., a twin function, to operate based on the result and the context. In some implementations, the query manager 565 can select the twin function based on the context and/or perform operates based on the context.

The twin function manager 567 can be configured to manage the execution of twin functions. The twin function manager 567 can receive an indication of a context query that identifies a particular data element and/or pattern in the graph projection database 562. Responsive to the particular data element and/or pattern occurring in the graph projection database 562 (e.g., based on a new data event added to the graph projection database 562 and/or change to nodes or edges of the graph projection database 562), the twin function manager 567 can cause a particular twin function to execute. The twin function can execute based on an event, context, and/or rules. The event can be data that the twin function executes against. The context can be information that provides a contextual description of the data, e.g., what device the event is associated with, what control point should be updated based on the event, etc.

### Systems and Methods of Automating Testing and Diagnostics

FIG. 6 depicts an example of a testing system 600 (e.g., testing and/or diagnostic system 600). The testing system 600 can be used to automate one or more aspects of a test of one or more systems or components in a building, such as one or more building subsystems 522 described with reference to FIG. 5 (e.g., and without limitation, any one or more security, video, HVAC, fire protection, or room management systems). For example, the testing system 600 can be used to automate one or more aspects of a test of a sprinkler system 650. As noted above and described in further detail below, the use of the testing system 600 to automate the test can facilitate more rapid testing to reduce system downtime during testing, allow for more flexible execution of tests given variations in components of sprinkler systems, and/or reduce computational and/or network communication demands by leveraging digital twin and/or graph data structure representations of components of the building subsystem 522 (e.g., the sprinkler system 650) and/or testing system 600. For example, the testing system 600 can allow for digital remote inspection of the sprinkler system 650 or components thereof, and can allow for test procedures to be configured electronically with lesser overhead associated with configuring appropriate control signals to transmit to electronic actuators for executing the test procedures and/or with parsing received data signals from sensors that monitor the test procedure. The testing system 600 can facilitate implementation of a connected sprinklers architecture. One or more components of the testing system 600 can be deployed on edge devices, such as to have computing elements structured for lightweight deployment on edge devices. The testing system 600 can perform targeted real-time image processing of components of the testing system 600 during the test procedure to facilitate detecting faults and/or satisfactory operation of components. Various components of the testing system 600 can be included in the sprinkler system 650 or vice versa.

Referring to FIG. 6, the sprinkler system 650 can distribute a fire suppressant agent onto or nearby a fire, extinguishing the fire and preventing the fire from spreading. The sprinkler system 650 can be used alone or in combination with other types of fire suppression systems (e.g., a building sprinkler system, a handheld fire extinguisher). Multiple sprinkler system 650 can be used in combination with one another to cover a larger area (e.g., each in different rooms of a building). The sprinkler system 650 can be used in a variety of applications. The sprinkler system 650 can be used with a variety of fire suppressant agents, including but not limited to water (e.g., may use powders, liquids, foams, or other fluid or flowable materials). Further, the sprinkler system 650 can be a wet pipe system, a dry pipe system, a deluge system, a pre-action system, an electronically activated fire suppression system, connected fire suppression systems, or the like.

The sprinkler system 650 can include or be coupled with a fluid supply 662. The fluid supply 662 can define an internal volume filled (e.g., partially filled, completely filled) with fire suppressant agent. The fluid supply 662 can provide fluid from a remote or local location to a building in which the sprinkler system 650 is located. The fluid supply may include, for example, a municipal water supply, pump, piping system, tank, cylinder, or any other source of water or fire suppression agent.

Piping 658 (e.g., one or more pipes, tubes, conduits, or fittings) can be fluidly coupled with one or more sprinklers 654. The sprinklers 654 can receive water or other fire suppressant agent from the fluid supply 662 via the piping 658. Due to the reduced pressures that can be achieved through the sprinklers 654 while still achieving target outputs of fluid, at least some of the piping 658 can have connections or outlets with relatively lesser diameters, such as 1 inch NPT or IS0-7-R1 connections or outlets. The piping 658 can be coupled with one or more valves 666 to control fluid flow from the fluid supply 662 to sprinklers 654 via the piping 658.

The sprinklers 654 can each define one or more outlets, through which the fire suppressant agent exits and contacts a deflector such as to form a spray of water or other fire suppressant agent that covers a desired area. The sprays from the sprinklers 654 then suppress or extinguish fire within that area.

The deflectors of the sprinklers 654 can be shaped to control the spray pattern of the fire suppressant agent leaving the sprinklers 654. The sprinklers 654 can be used as concealed sprinklers, pendent sprinklers, upright sprinklers, water mist nozzles, or any other device for spraying fire suppressant agent.

The sprinklers 654 can include an activation element (e.g., thermal element). The activation element can change from a first state that prevents fluid flow out of the sprinkler 654 to a second state that permits fluid flow of the sprinkler 654 responsive to a fire condition.

For example, the activation element can include a glass bulb including a fluid that expands responsive to an increase in temperature (e.g., responsive to heat provided to the fluid from a fire), such as to cause the glass bulb to break responsive to the temperature meeting or exceeding a threshold temperature. In another example, the activation element can include a fusible link that includes two or more pieces coupled using a solder than can melt responsive to the temperature meeting or exceeding a threshold temperature. In yet another example, the activation element can include an electric actuator (e.g., an electrically triggered pyrotechnic actuator or electrically actuated bulb or link). The activation element can have a response time index (RTI) less than or equal to 80 (m/s)1/2, or less than or equal to 50 (m/s)1/2. The activation element can have a response time index (RTI) less than or equal to 520 (m/s)1/2 and greater than or equal to 15 (m/s)1/2. The activation element can have a temperature rating (e.g., nominal temperature at which the activation element changes from the first state to the second state) of 155 degrees Fahrenheit or greater.

The sprinklers 654 can be arranged (e.g., in a grid or tree arrangement over a storage commodity) to have sprinkler to sprinkler spacings greater than or equal to eight feet by eight feet, including but not limited to fourteen feet by fourteen feet.

Referring further to FIG. 6, the testing system 600 can include a test manager 604. The test manager 604 can include one or more components of the data platform 500 described with reference to FIG. 1. This can allow the test manager 604 to connect devices from edge to cloud, to provide cohesive data visualization (e.g., with respect to multiple operations and/or components at each operation of a test), to issue commands, and/or to gain intelligence from the building and components of the sprinkler system 650 and testing system 600.

The test manager 604 can include or be coupled with one or more system data structures 608, which can incorporate features of the digital twins and/or graph data structures described with reference to FIG. 5, and can represent information regarding and/or relationships amongst components of the testing system 600, sprinkler system 650, and/or building(s) or portions of buildings in which the components of the testing system 600 and sprinkler system 650 are disposed. For example, the test manager 604 can perform data processing operations, such as graph data operations, described with reference to FIG. 5, to normalize and/or consolidate data from disparate sources (e.g., sensors 616 and/or actuators 624 described further herein) for more efficient network communication or data storage. The test manager 604 can be coupled with (e.g., by any of various wired and/or wireless connections) various components, such as for reception of data signals (e.g., sensor data, status data) from remote devices and/or transmission of, for example and without limitation, control signals, alerts, or status updates to remote devices.

In some implementations, the test manager 604 identifies various components of the building 10. The components can include a security system, a fire protection system, a sprinkler system (e.g., sprinkler system 650), or the HVAC system 20. The test manager 604 may select one or more of the components of the building 10 utilizing the graph projection database 562. The graph projection database 562 can include digital replicas of the components of the building 10, including the building subsystems 522, e.g., sprinklers, pressure sensors, valves, pumps, actuators, etc. The test manager 604 may test each component of the building subsystems 522 (e.g., by operating sprinklers, pressure sensors, valves, actuators, pumps, etc.).

The test manager 604 can include a test data structure 612. The test data structure 612 can represent a test procedure, to be performed on one or more components of the sprinkler system 650. The test data structure 612 can include structured and/or unstructured (e.g., unlabeled; freeform) data. The test data structure 612 can include any one or more rules, heuristics, policies, logic, models, or algorithms representative of the test. The test can include, for example, a sequence of operations to be performed on the one or more components of the sprinkler system 650, and can include triggers associated with the operations (e.g., responsive to a first operation being performed on a first component causing a first result, a second operation can be selected to be performed on a second component; responsive to the first operation causing a second result, a third operation can be selected, where the third operation can be an operation to perform on the second component or a third component, or can be a trigger for data processing and/or output, e.g., for alarm output). In some implementations, the test data structure 612 includes operations corresponding to one or more regulatory (e.g., NFPA, UL, FM) criteria for target performance of the system on which the test is to be performed. The test data structure 612 can indicate timing criteria (e.g., scheduling) for any one or more operations and/or tests, such as to indicate Various examples described herein can be used to facilitate remote inspection and testing of drain valves, though any of various other systems and/or devices can be tested in accordance with the present disclosure.

The test manager 604 can generate (e.g., for presentation by a user interface and/or display device) a representation of the test data structure 612. For example, the test manager 604 can generate the representation to include graphical elements corresponding to one or more operations of the test data structure 612. The representation can be a dashboard, such as a centralized dashboard for visualization of the test and/or progress of the test, including for real-time or near real-time presentation. This dashboard may include graphical elements corresponding to the various operations and stages of the test procedure. For example, the dashboard can present real-time data on actuator positions, sensor readings, and test progress, using visual cues such as gauges, charts, and status indicators. Additionally or alternatively, the output generated by the test manager 604 can include reports or logs that detail the test's outcome, deviations from operational parameter thresholds, and recommendations for maintenance or further testing.

The testing system 600 can include one or more sensors 616. The sensors 616 can provide sensor data indicative of operational values (e.g., pressure, flow rate, temperature, etc.) to the test manager 604 and/or fire control panel 620. The sensors 616 can include or be coupled with any of various wired and/or wireless communication electronics (e.g., and without limitation, RFID, LoRA, Bluetooth, Wi-Fi, etc.). The sensors 616 can include one or more temperature, pressure, and/or water presence sensors. For example, the sensors 616 can include one or more pressure sensors coupled with corresponding valves and/or piping (e.g., piping 658), such as to detect static and/or residual pressures associated with the corresponding valves. The sensors 616 can include at least one flow sensor, such as a flow switch (e.g., pressure switch; paddle switch), to indicate presence, change in pressure, and/or flow of fire suppressant at a given location.

The sensors 616 can include an image capture device (e.g., camera, such as a fixed or movable (e.g., PTZ) camera) to facilitate visual inspection of one or more components of the sprinkler system 650, such as to be triggered to capture image(s) of the one or more components responsive to corresponding trigger events. By providing both the test manager 604 and image capture device in the testing system 600, the testing system 600 can provide comprehensive output of actions and/or states of components at the time of visual inspection by the image(s) captured by the image capture device.

The testing system 600 can include or be coupled with one or more controllers, e.g., fire control panels 620. For example, the testing system 600 can include a communication interface, such as a gateway, coupled with the fire control panel 620 to facilitate communication with and/or data retrieval from the fire control panel 620. In some implementations, the test manager 604 is at least partially implemented by a given fire control panel 620. The fire control panel 620 can perform at least one operation of the test represented by the test data structure 612. To allow for remote inspection to be performed, the testing system 600 can perform at least one of visual or communicative monitoring of the fire control panel 620 (e.g., by communication using the gateway and/or use of an image capture device to capture images of output indicators of the fire control panel 620). The fire control panel 620 can include one or more user interface elements to receive inputs for operation of the fire control panel 620 and/or present information regarding operation of the fire control panel 620 and/or one or more components coupled with the fire control panel 620. The fire control panel 620 can present information in various formats, such as (alpha)numerical codes, color-based indications, text information, graphical elements, or various combinations thereof.

In some implementations, the fire control panel 620 (e.g., responsive to a command from the test manager 604 and/or via the user interface element(s) of the fire control panel 620) can be set to one or more modes, such as a test mode. For example, in the test mode, the fire control panel 620 can receive an indication of a fire condition (e.g., from one or more detectors 628) and can determine to not trigger operation of at least a portion of the sprinkler system 650 responsive to being in the test mode at the time of reception of the indication. In some implementations, the sprinkler system 650 (e.g., sprinklers 654 and/or corresponding detectors 628) can have zones of one or more grouped detectors 628 and/or sprinklers 654, which the fire control panel 620 can selectively operate in test mode (e.g., test mode for a first zone and not a second zone, etc., such as a walk test mode). This can allow, for example, a smoke reading in a first zone to still initiate a true alarm for the first zone while performing a test for the second zone. In some implementations, responsive to setting the fire control panel 620 in the test mode, the test manager 604 can monitor information received and/or outputted by the fire control panel 620, such as to detect an actual fire condition and/or trigger an alarm responsive to detecting the actual fire condition (e.g., distinct from the indications corresponding to the operations of the test which are not intended to cause triggering of an alarm or operation of the sprinkler system 650).

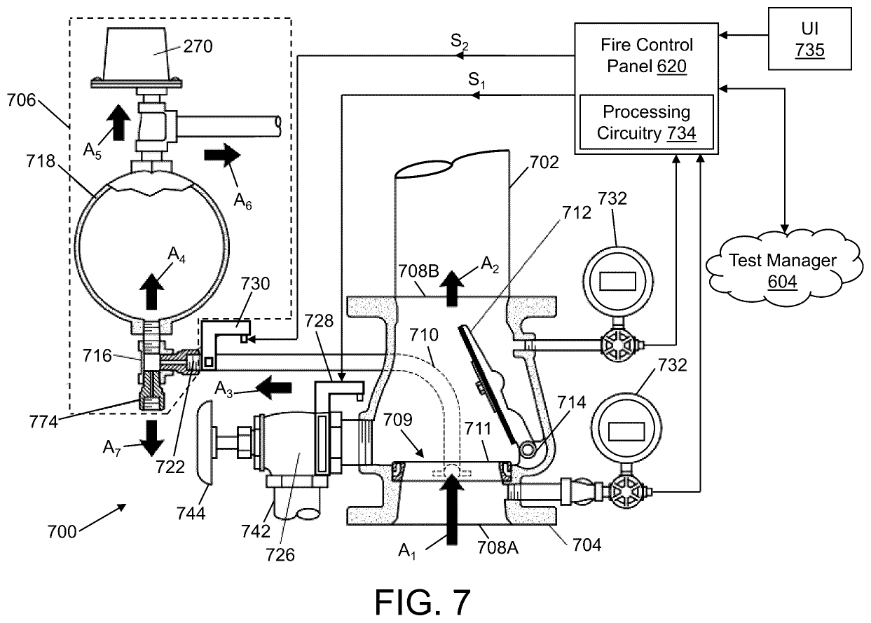

The testing system 600 can include or be coupled with one or more actuators 624. The actuators 624 can be used to control (e.g., activate, trigger, modify, deactivate) operation of one or more corresponding components of the sprinkler system 650, such as valves and/or pumps. For example, the actuators 624 can include a first actuator to actuate a drain 670 (e.g., valve coupled with a drain pipe and/or main drain pipe, such as for output of fluid outside of the building and/or to a drain in the building) of the sprinkler system 650. The actuators 624 can include a second actuator to actuate a valve coupled with an inspection point. The actuators 624 can include a third actuator to actuate one or more pumps 668. The actuators 624 can include any one or more actuators described with reference to FIG. 7 (e.g., actuator 728). The actuators 624 can include electrical switches, relays, valves (e.g., solenoid valves), or various combinations thereof (i.e., “activators”). In some examples, a single actuator 624 is configured to actuate multiple components of the sprinkler system. For example, one actuator 624 may activate/actuate the drain 670, the pumps 668, and/or a flow switch (e.g., using a linkage mechanism that translates the actuator's motion to connected components, using combined activation, using modified electrical or pneumatic signals, etc.).

The testing system 600 and/or the sprinkler system 650 can include or be coupled with one or more pumps 668. The pumps 668 can be for providing fire suppression agent (e.g., from a fluid supply) to piping 658 or various other components of the sprinkler system 650, such as to pressurize the piping 658 to a target pressure. The actuators 624 can be used to trigger operation of pumps 26P8 and/or valves.

The testing system 600 can include or be coupled with one or more detectors 628. The detectors 628 can include any one or more devices to detect an indication of a fire condition. The detectors 628 can include, for example, one or more smoke detectors, heat detectors, temperature sensors, or various combinations thereof. The sensors 616 can include or be coupled with one or more detectors 628. A given detector 628 can be associated with one or more portions of the building and/or one or more sprinklers 654. For example, the test manager 604 (e.g., using a graph data structure) can store associations between detector(s) 732 and sprinkler(s) 654 representative of positional and/or operational relationships between the detectors 628 and sprinklers 654, such as to indicate which sprinklers 654 are to operated and/or to be provided fire suppression agent responsive to the indication of fire condition received from the detectors 628. The association can correspond to a zone of one or more grouped detectors 628 and/or sprinklers 654.

FIG. 7 depicts a system 700, such as at least a portion of the testing system 600 and/or sprinkler system 650, for which the testing system 600 can perform one or more tests (e.g., one or more operations of a test of the sprinkler system 650). The system 700 includes a supply conduit 702 (e.g., a primary flow path) that connects supply source of fire suppression agent (e.g., water) to system's distribution conduits (e.g., the piping system 658 shown in FIG. 6). The system 700 may serve as a central point from where the fire suppression agent is delivered to the sprinkler system 650. The system 700 may further include an alarm check valve 704 coupled between the supply conduit 702 and the supply source of the fire suppression agent, and an alarm assembly 706 coupled to the alarm check valve 704.

The alarm check valve 704 has an inlet 708A coupled to the supply source and an outlet 708B coupled to the supply conduit 702. The alarm check valve 704 includes an alarm port 709, formed by a centrally located groove 710 in a seat ring 711, coupled to the alarm assembly 706. In some implementations, the seat ring 711 may be a circular component positioned within the alarm check valve 704 to serve as a sealing surface for the alarm check valve 704. The groove 710 may be a narrow channel positioned in the center of the seat ring 711. The groove 710 may function as a secondary flow path through which the fire suppression agent may enter the alarm assembly 706 from the alarm check valve 704, thus, ensuring that a portion of the fire suppression agent flows through the groove 710 and then to the alarm assembly 706.

The alarm check valve 704 further includes a clapper 712 and a torsion spring 714. In some implementations, the clapper 712 may be a hinged plate that functions as a barrier within the alarm check valve 704. The clapper 712 is configured to move in a direction indicated by arrow A1 to allow the fire suppression agent to flow from the supply source to the supply conduit 702 via the alarm check valve 704 and prevent backflow of the fire suppression agent into the supply source. In some implementations, the clapper 712 is coupled to a body of the alarm check valve 704 via a hinge, allowing the clapper 712 to pivot. Further, the clapper 712 may press against the seat ring 711 when the alarm check valve 704 is closed. The torsion spring 714 is configured to provide required force to keep the clapper 712 closed when there is no flow of the fire suppression agent. In some implementations, the torsion spring 714 on one end is attached to the hinged end of the clapper 712 and anchored to a fixed point on the body of the alarm check valve 704 on the other end.

The alarm assembly 706 includes a restriction assembly 716, a retard chamber 718, and a pressure alarm switch 720. The restriction assembly 716 is coupled to the groove 710, and is configured to regulate the flow of the fire suppression agent into the retard chamber 718. The restriction assembly 716 has an inlet orifice 722 coupled to the alarm check valve 704 and an outlet orifice 724. The restriction assembly 716 has another opening, substantially opposite the outlet orifice 724, that is coupled to the retard chamber 718.

In some implementations, the retard chamber 718, connected downstream from the restriction assembly 716, acts as a buffer, allowing the fire suppression agent to accumulate therein and reach a stable pressure before the fire suppression agent reaches the pressure alarm switch 720. The retard chamber 718 stabilizes the pressure of the fire suppression agent and prevents triggering of false alarms.

The pressure alarm switch 720 is a safety feature in the fire suppression system that is coupled to the retard chamber 718. The pressure alarm switch 720 is configured to monitor the pressure of the fire suppression agent in the retard chamber 718. If the pressure exceeds or falls below a threshold value, for example, due to leak, system malfunction, or a sprinkler action in case of a fire, the pressure alarm switch 720 is triggered. Thus, alerting building occupants and emergency responders regarding an emergency issue.

When the fire suppression system (e.g., the sprinkler system 650) is initially pressurized (e.g., when the alarm check valve 704 is connected to the supply source or when the fire suppression agent supply is resumed), the clapper 712 opens (as shown in FIG. 7) due to a pressure difference between the supply source and the fire suppression system. With the clapper 712 being open, the fire suppression agent flows into the fire suppression system until the pressure at the supply source becomes equal to the pressure in the fire suppression system.

In response to the pressure at the supply source becoming equal to the pressure in the fire suppression system, spring action of the torsion spring 714 closes the clapper 712 and the centrally located groove 710 in the seat ring 711 gets sealed. Consequently, with the centrally located groove 710 being sealed, there is no flow of the fire suppression agent through the alarm port 709 to the alarm assembly 706. The alarm check valve 704 is thus successfully set for service.

In an event of a sprinkler operation, the pressure in the fire suppression system decreases. Consequently, the clapper 712 opens and the fire suppression agent flows into the fire suppression system as shown by arrows A1 and A2. Arrow A2 indicates the primary flow path of the fire suppression agent. The fire suppression agent is then permitted to flow into the centrally located groove 710 towards the restriction assembly 716 (e.g., the secondary flow path as shown by arrow A3). When the flow of the fire suppression agent through the inlet orifice 722 exceeds the flow through the outlet orifice 724, the retard chamber 718 begins to fill with the fire suppression agent (as shown by arrow A4). Subsequently, a motor alarm and/or the pressure alarm switch 720 may be actuated due to further flow of the fire suppression agent in directions indicated by arrows A5 and A6. The alarms may continue to be actuated as long as the clapper 712 remains open.

The fire suppression agent accumulated in the retard chamber 718 may automatically drain out through the outlet orifice 724 (as indicated by arrow A7) when the clapper 712 closes, for example, due to a stop in the flow of the fire suppression agent into the fire suppression system. The retard chamber 718 accommodates transient surge in supply pressure that is sufficient only to open the clapper 712 momentarily, and hence prevents false alarm.

National Fire Protection Association (NFPA) standard has established various rules and guidelines for performing testing on fire suppression systems to ensure health of the system. Drain test is one such test typically performed on fire suppression systems to monitor changes in fire suppression agent flow through the fire suppression system. For example, as per NFPA standard, drain test is to be performed annually, any time fire suppression agent supply is cut off, after any maintenance activity is performed on the fire suppression system, etc. Conventional or existing set-up for performing drain test is cumbersome, labor intensive, exhibits precision and accuracy delays, lacks data validation for enhancements, and faces challenges in data storage and management.

In order to address the shortcomings of conventional fire suppression systems, and also to minimize the risks of system downtime, the present disclosure describes an arrangement incorporated in the fire suppression system (e.g., the sprinkler system 650) to automate drain tests. The arrangement (e.g., the automated drain test assembly) to automate the drain test comprises a drain valve 726, a first actuator 728, a second actuator 730, one or more sensors 732 (e.g., sensors 616), and processing circuitry 734. In some implementations, the processing circuitry 734 may be included in the fire control panel 620. In some other implementations, the processing circuitry 734 may be included in a remote server coupled to the fire control panel 620 via the network 504. The processing circuitry 734 may be distributed across the remote server and the fire control panel 620 such that certain functionalities of the processing circuitry 734 are implemented at the fire control panel 620 and certain other functionalities of the processing circuitry 734 are implemented at the remote server. In some other implementations, the processing circuitry 734 may be implemented at building management system level. In some other implementations, the processing circuitry 734 may be provided as a standalone controller or device for automating drain tests.

The drain valve 726 is a normally closed valve having an inlet coupled to the alarm check valve 704 and an outlet coupled to a drain conduit 742. The drain valve 726 allows for controlled drainage of the fire suppression agent during the drain test. When the drain valve 726 is closed, a sealing mechanism (not shown) of the drain valve 726 prevents the fire suppression agent to pass through the drain valve 726, thus preventing any leakage when drain test is not being performed. Examples of the drain valve 726 may include, but are not limited to, a quarter-turn ball valve, a gate valve, a butterfly valve, or the like.

The first actuator 728 is coupled to the drain valve 726 for controlling a position of the drain valve 726. The first actuator 728 may be further coupled to the processing circuitry 734 for receiving a control signal S1 (e.g., a voltage or a current signal) that energizes the first actuator 728. For example, when energized, the first actuator 728 may drive the drain valve 726 from a closed position to an open position. The open position may be a completely open position or a partially opened position as required for performing the drain test. The first actuator 728 when de-energized may drive the drain valve 726 back to the closed position.

The second actuator 730 is coupled to the inlet orifice 722 of the restriction assembly 716 for controlling a position of the inlet orifice 722. In some implementations, the inlet orifice 722 may incorporate therein a mechanically opened valve controlled by the second actuator 730. The second actuator 730 may be further coupled to the processing circuitry 734 for receiving a control signal S2 (e.g., a voltage or a current signal) that energizes the second actuator 730. For example, when energized, the second actuator 730 may drive the inlet orifice 722 from an open position to a closed position for performing the drain test. The second actuator 730, when de-energized, may drive the inlet orifice 722 back to the open position. In other words, the inlet orifice 722 remains closed during the drain test. For example, the inlet orifice 722 is closed at the beginning of the drain test and is opened at the end of the drain test. Examples of the first and second actuators 728 and 730 may include, but are not limited to, mechanical actuators, electric actuators, solenoid actuators, motor actuators, hydraulic cylinders or the like.

The sensors 732 may include digital sensors, such as, for example, pressure sensors, configured to generate sensor data based on monitoring and recording pressure of the fire suppression system. In some implementations, the sensors 732 may be installed proximal to the inlet 708A and the outlet 708B of the alarm check valve 704. The sensors 732 can be further installed proximal to (e.g., before and after) the drain valve 726. The sensor data generated by the sensors 732 is provided to the processing circuitry 734 via a communication channel (wired or wireless) for determining an outcome of the drain test. In some implementations, the sensors 732 may be provided with inbuilt memory configured to temporarily store the sensor data generated during the drain test and provide the sensor data to the processing circuitry 734 at the completion of the drain test. In some implementations, the sensors 732 may include limited memory storage. In such an implementation, the processing circuitry 734 may be configured to instruct the sensors 732 to erase previously stored data prior to commissioning the drain test. The use of digital sensors 732 to record and transmit the sensor data generated during the drain test to the processing circuitry 734 improves the precision and accuracy of the drain test. Further, as the generated sensor data is stored at the processing circuitry 734 and/or in the inbuilt memory of the sensors 732, the stored sensor data can be used as a reference for historical records. The processing circuitry 734 can be used to implement at least a portion of the functionality of the test manager 604. The processing circuitry 734 can store threshold values (e.g., target static and residual pressure values) required for performing drain test.

In some implementations, the processing circuitry 734 may be connected to or configured to incorporate a user interface (UI) 735 that permits an operator to interact with the processing circuitry 734. The operator can select and enter commands for the processing circuitry 734 through the UI 735. In addition, the UI 735 can display messages and information from the processing circuitry 734 regarding the operational status of the sprinkler system 650 for the operator. The UI 735 can be located locally to the processing circuitry 734, such as being mounted on the fire control panel 620. The UI 735 can be located remotely from the fire control panel 620, such as being located in a separate control room, at the remote server, or a computing device of the operator or admin. In some implementations, the UI 735 may be used by an admin or system operator to send a trigger command for initiating a drain test.

In operation, the processing circuitry 734 may be configured to schedule the drain test for the fire suppression system (e.g., the sprinkler system 650). In some implementations, the processing circuitry 734 may schedule the drain test in accordance with National Fire Protection Association (NFPA) standard. For example, the processing circuitry 734 may schedule an annual drain test for the fire suppression system to ensure system health. In another example, the processing circuitry 734 may schedule a drain test when the fire suppression agent supply is resumed after being cut off for some duration. In another example, the processing circuitry 734 may schedule a drain test subsequent to a maintenance activity being performed on the fire suppression system to ensure that the system health is not affected by the maintenance activity. In another example, the processing circuitry 734 may have preset guidelines stored in the memory for trigger events that prompt scheduling of drain test. In some implementations, the processing circuitry 734 may communicate with the BMS to schedule the drain test. For example, the processing circuitry 734 may obtain building occupancy status and trend from the BMS, and may select that time period for drain test when the building or establishment experiences the lowest levels of occupancy.

In some implementations, the processing circuitry 734 may be configured to seek an approval or confirmation from an admin or supervisor of the fire suppression system on the scheduled drain test. For example, upon scheduling the drain test, the processing circuitry 734 may be configured to send a notification on a computing device of the system admin for notifying regarding the scheduled drain test. The notification may include a confirm option, which, when selected by the admin, sends a confirmation response to the processing circuitry 734. The notification may further include a re-schedule option, which, when selected by the admin, prompts the admin to provide an alternate time/date slot for performing the drain test. In a scenario, when the admin selects the re-schedule option and provides the alternate time/date slot, the processing circuitry 734 reschedules the drain test to the alternate time/date slot. The processing circuitry 734 initiates the drain test as per the set schedule.

In some implementations, the processing circuitry 734 may be configured to retrieve/receive sensor data from the sensors 732 indicating initial static pressure of the fire suppression agent prior to the opening of the drain valve 726. Upon recording initial static pressure sensor data, the processing circuitry 734 may be configured to transmit the control signal S2 to the second actuator 730 to energize the second actuator 730 for closing the inlet orifice 722 of the alarm assembly 706. The inlet orifice 722 may remain closed during the drain test. Closing of the inlet orifice 722 during the drain test ensures that no false alarms are triggered by the alarm assembly 706 during the drain test.

Once the inlet orifice 722 is closed, the processing circuitry 734 may be configured to transmit the control signal S1 to the first actuator 728 to energize the first actuator 728 to open the drain valve 726 for a defined time duration, for example, a duration specified by NFPA, or for a duration until residual pressure of the fire suppression agent stabilizes. In response to the opening of the drain valve 726, pressure in the fire suppression system decreases. Consequently, the clapper 712 opens and the fire suppression agent flows into the fire suppression system as shown by arrows A1. Since the inlet orifice 722 is in the closed position and no sprinklers are actuated, the primary and secondary flow paths of the fire suppression agent are restricted. Thus, the fire suppression agent entering into the fire suppression system discharges via the opened drain valve 726 and the drain conduit 742 for the defined time duration.

Due to fluid dynamics and fluid inertia, residual pressure in the fire suppression system may take some time to stabilize. In other words, the residual pressure in the fire suppression system may fluctuate immediately after opening the drain valve 726. Residual pressure refers to pressure that remains within the fire suppression system when the fire suppression agent is flowing. In some implementations, the sensors 732 may be configured to measure the residual pressure of the fire suppression agent after a delay time interval from the opening of the drain valve 726 to generate the sensor data for residual pressure. The sensors 732 may be pre-programmed with the delay time interval as per system design pressure and supply source requirements. For example, the sensors 732 may receive a trigger signal from the processing circuitry 734 when the drain valve 726 is opened. The sensors 732 may measure the residual pressure of the fire suppression agent after a delay time interval from receiving the trigger signal. The sensors 732 may then transmit the sensor data indicating the residual pressure of the fire suppression agent to the processing circuitry 734.

Upon successful recording of the residual pressure, the processing circuitry 734 may be configured to de-energize the first actuator 728, which in turn drives the drain valve 726 to the closed position, thus stopping the discharge of the fire suppression agent via the drain valve 726. The processing circuitry 734 may be further configured to activate a timer in response to closing the drain valve 726 after the defined time duration. The processing circuitry 734 may be further configured to de-energize the second actuator 730, which in turn drives the inlet orifice 722 to the open position, thus enabling the alarm assembly 706.

Responsive to the drain valve 726 closing, the fire suppression system experiences transient pressure changes as the flow of the fire suppression agent ceases. These pressure fluctuations take some time to dissipate due to fluid dynamics. The processing circuitry 734 activates the timer to determine the time taken by the pressure fluctuations to dissipate once the drain valve 726 is closed. Responsive to the system stabilizing, the clapper 712 closes and the sensors 732 transmit sensor data indicating a final static pressure to the processing circuitry 734. The processing circuitry 734 may stop the timer and record the timer value of the stopped timer in response to the final static pressure being recorded successfully. In some examples, the final static pressure is same as the initial static pressure, and the timer value indicates the delay the system exhibits in achieving the initial static pressure from the from the residual pressure once the drain valve 726 is closed.

In some implementations, the processing circuitry 734 may be further configured to process and compare the sensor data along with the timer value with certain criteria, such as preset drain test thresholds (e.g., static and residual pressure thresholds, threshold time to achieve static pressure from and residual pressure, or the like), and historical drain test data to determine an outcome of the drain test. In a scenario where deviation of the sensor data from the preset drain test thresholds is within permissible limits as per NFPA standards, the processing circuitry 734 establishes that the drain test is successfully completed with no faults detected in the fire suppression system. However, where deviation of the sensor data from the preset thresholds is outside the permissible limits, the processing circuitry 734 establishes that the drain test is successfully completed with faults detected in the fire suppression system. For example, if the supply source is clogged or blocked, required flow of the fire suppression may not be achieved. In such a scenario, the residual pressure recorded during the drain test may not satisfy the residual pressure threshold and the time to achieve static pressure from the residual pressure may be lower/greater than the threshold time. Hence, the processing circuitry 734 may establish that the drain test is successfully completed with faults detected in the fire suppression system. The processing circuitry 734 may then alert the system admin regarding faults detected in the fire suppression system and may generate a recommendation for site visit for detailed system analysis and troubleshooting.

In some implementations, the drain valve 726 is provided with a mechanical lever 744 to manually operate the drain valve 726. The lever 744 may be utilized to manually override the control of the processing circuitry 734 in events of emergency.

In some other implementations, the sensors 732 may be configured to transmit the sensor data indicating the initial static pressure of the fire suppression agent prior to the opening of the drain valve 726, the residual pressure of the fire suppression agent while the drain valve 726 is opened, and the final static pressure of the fire suppression agent after the drain valve 726 is closed again in one go, for example, at the end of the drain test.

In some other implementations, the processing circuitry 734 may be configured to receive sensor data from the sensors 732 in real time or near real time (e.g., timeseries of sensor data). The processing circuitry 734 may then process the received sensor data to determine the initial static pressure of the fire suppression agent, the residual pressure of the fire suppression agent, and the final static pressure of the fire suppression agent. For example, the processing circuitry 734 may consider the pressure data recorded by the sensors 732 prior (e.g., 5 seconds, 10 seconds, etc.) to the opening of the drain valve 726 as the initial static pressure of the fire suppression agent. Further, the processing circuitry 734 may consider the pressure data recorded by the sensors 732 after (e.g., 5 seconds, 10 seconds, etc.) the opening of the drain valve 726 as the residual pressure of the fire suppression agent. While determining the residual pressure, the processing circuitry 734 may discard the fluctuating pressure data recorded immediately after the opening of the drain valve 726 and may consider the stabilized pressure data as residual pressure of the fire suppression agent. Further, the processing circuitry 734 may consider the stabilized pressure data recorded by the sensors 732 after (e.g., 5 seconds, 10 seconds, etc.) the closing of the drain valve 726 as the final static pressure of the fire suppression agent. While determining the final static pressure, the processing circuitry 734 may analyze the sensor data to understand for how long the pressure fluctuated after the drain valve 726 was closed before stabilizing to the final static pressure.

In some implementations, the sensors 732 may be configured and/programmed to automatically transmit the initial static pressure of the fire suppression agent, the residual pressure of the fire suppression agent, and the final static pressure of the fire suppression agent while discarding the fluctuating pressure data.

In some implementations, where the processing circuitry 734 is implemented locally at the fire control panel 620, functionalities such as scheduling of the drain test, controlling the first and second actuators 728 and 730 for executing the drain test, receiving sensor data from the sensors 732, and determining an outcome of the drain test are implemented locally at the fire control panel 620.

In some implementations, where the processing circuitry 734 is implemented remotely at the server, functionalities such as scheduling of the drain test, controlling the first and second actuators 728 and 730 for executing the drain test, receiving sensor data from the sensors 732, and determining an outcome of the drain test are controlled remotely by the server.

In some implementations, where the processing circuitry 734 is distributed across the fire control panel 620 and the server, functionalities such as scheduling of the drain test, controlling the first and second actuators 728 and 730 for executing the drain test, receiving sensor data from the sensors 732, and determining an outcome of the drain test are also distributed across the fire control panel 620 and the building data platform 500 (e.g., via the network 504). For example, the test manager 604 may schedule the drain test and communicate the schedule to the fire control panel 620. Consequently, the fire control panel 620 may execute the drain test, receive the sensor data from the sensors 732, and communicate to the server for processing and determining drain test outcome. In some implementations, the fire suppression agent discharged during the drain test may be collected in a drain tank (not shown), processed to remove debris (if any), and then supplied back to the supply source.

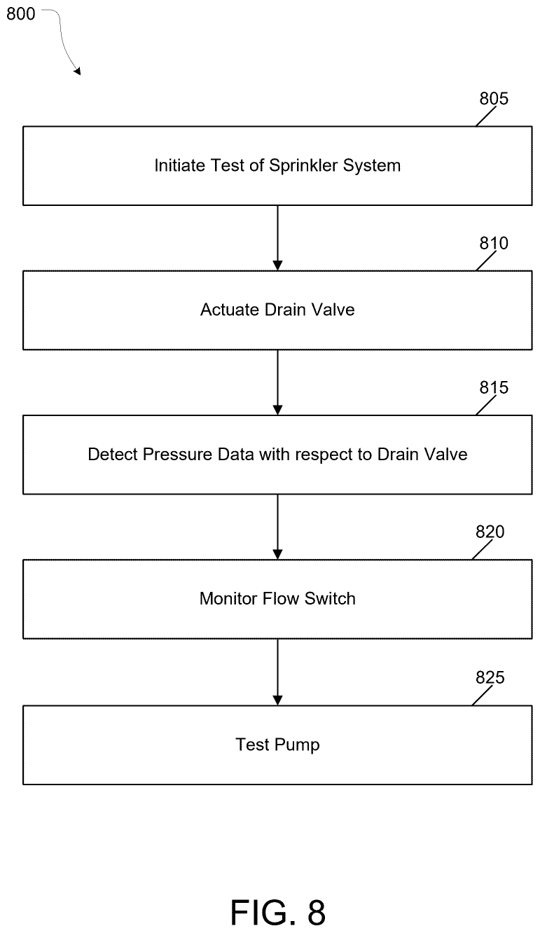

FIG. 8 depicts a method 800 of automation of a testing of one or more components of a building system. The method 800 can be performed using various systems described herein, such as the systems 500, 600, 700. While the method 800 is described with reference to sprinkler system testing, various operations of the method 800 can be implemented for various building subsystem tests.

At 805, a test can be initiated. Initiating the test can include causing (e.g., by output of an initiation signal from a test controller) a sprinkler system controller, such as a fire panel (e.g., fire control panel) to be set to a test mode. For example, the initiation signal can be transmitted to the fire panel having instructions to set the fire panel to the test mode, such as to allow for remote initiation of the test. An input can be provided (e.g., by a user interface of the fire panel) to set the fire panel to the test mode. Setting the fire panel to the test mode can include causing the fire panel to receive indications of fire conditions (e.g., smoke readings) without triggering actions to cause output of fire suppressant.

At 810, a drain (e.g., main drain) can be actuated. The drain can be actuated responsive to detection of successful setting of the fire panel to the test mode. The drain can be actuated by transmission, by the test controller, of an actuation signal to an actuator coupled with the drain. Testing of the drain can be used to confirm whether the water supply to the sprinkler system has not (or has) degraded, e.g., relative to one or more target characteristics (e.g., flow rate, corrosion presence, leaks, etc.).

At 815, one or more pressures can be detected with respect to the drain, such as by one or more pressure sensor coupled with the drain and/or with piping coupled with the drain. The pressures can include, for example, a static pressure of fluid at or proximate the drain (which can be detected prior to actuation of the drain). The pressures can include, for example, a residual pressure of fluid at or proximate the drain, which can be detected subsequent to actuation of the drain. The one or more pressures can be stored in memory by the test controller and/or transmitted to a remote database for storage and/or further processing. The detected pressures can be compared with one another and/or with prior readings (e.g., in a prior test) to evaluate the water supply to the sprinkler system. The one or more pressures can be received (e.g., by wired and/or wireless connection) by the fire panel and/or the test controller and can be evaluated by the fire panel and/or test controller. Responsive to the evaluation of the one or more pressures not satisfying a corresponding criteria (e.g., pressure relative to a prior test has decreased more than a threshold amount), an error can be outputted.

At 820, monitoring of a signal from a flow switch is performed. The flow switch can be coupled with a fluid output device (e.g., another drain or an inspection point sprinkler), which can be actuated subsequent to actuation of the drain, such as to detect flow and/or change in pressure responsive to the actuation of the fluid output device. For example, the monitoring of the signal from the flow switch can be performed subsequent to the actuation of the drain. As part of the test, detection of the signal from the flow switch can confirm proper operation of the flow switch. The signal can be monitored by the test controller being coupled with the flow switch and/or via monitoring of the fire panel. Responsive to the signal not being detected and/or indicating an error, an error regarding the flow switch can be detected and/or outputted.

At 825, one or more operations for testing a pump can be performed. For example, an actuator coupled with the pump, such as with a sensing line and/or a valve coupled with the sensing line of the pump, and/or a relay coupled with the pump controller, can operate the valve to facilitate flow to and/or by the pump. Testing the pump can include monitoring an operating signal regarding the pump (e.g., outputted from the pump or from a sensor coupled with the pump), e.g., as communicated to the fire panel and/or test controller. Monitoring the operating signal can include monitoring at least one of a pump run indicator, a loss of power (e.g., AC power) indicator, or phase reversal indicator. For example, the pump controller of the pump can transmit one or more signals corresponding to the operating signal to the fire panel and/or the test controller. In some implementations, a second pump (e.g., jockey pump) can be operated and/or used to restore pressure to the pump, which can facilitate triggering the pump to transmit the operating signal.

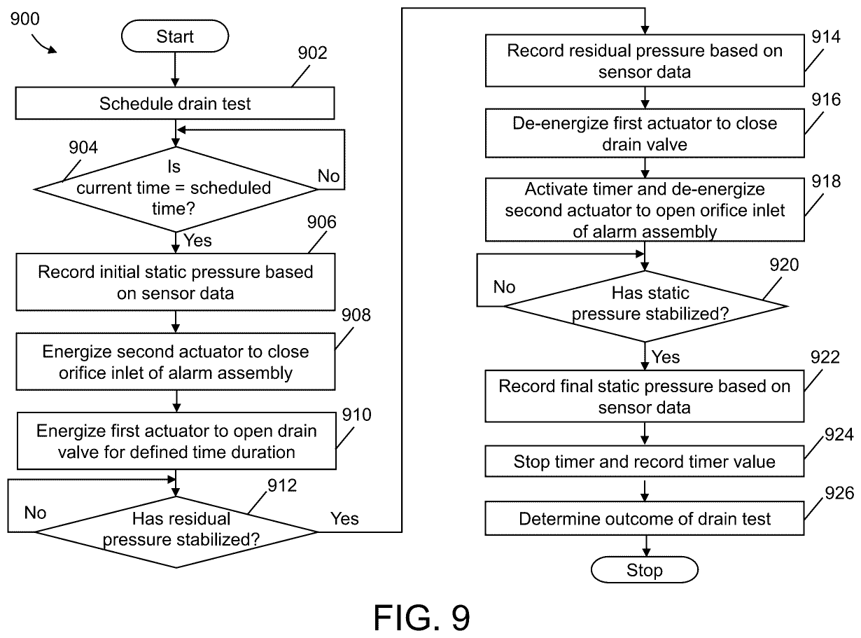

Referring now to FIG. 9, a flow chart of a method 900 for performing automated drain test on a fire suppression system is shown, according to some embodiments. In some embodiments, operations 902-926 of the method 900 may be performed by one or more components shown in FIG. 7.

At 902, the processing circuitry 734 may be configured to schedule a drain test for a fire suppression system having automated drain test assembly (described in foregoing description of FIG. 6). In some embodiments, the processing circuitry 734 may schedule the drain test in accordance with NFPA standard. At 904, the processing circuitry 734 may be configured to determine whether current time is same as scheduled time for drain test. If at 904 the processing circuitry 734 determines that the scheduled time for drain test has not arrived yet, control remains at 904. However, if at 904 the processing circuitry 734 determines that the scheduled time for drain test has arrived, the processing circuitry 734 starts the drain test and control passes to 906. At 906, the processing circuitry 734 may be configured to receive sensor data from the sensors 732 and record initial static pressure of the fire suppression agent based on the received sensor data. Initial static pressure refers to pressure within the fire suppression system when the fire suppression agent is not flowing. At 908, the processing circuitry 734 may be configured to energize the second actuator 730 to close the inlet orifice 722 of the alarm assembly 706 to prevent triggering of false alarms during drain test. Thus, the inlet orifice 722 remains closed for the entire duration of the drain test.

At 910, the processing circuitry 734 may be configured to energize the first actuator 728 to open the drain valve 726 for a defined time duration. Thus, causing the fire suppression agent to discharge via the drain valve 726 for the defined time duration. At 912, based on sensor data from the sensors 732, the processing circuitry 734 may be configured to determine whether residual pressure within the fire suppression system has stabilized after opening the drain valve 726. Due to fluid dynamics and fluid inertia, the residual pressure in the fire suppression system may fluctuate immediately after opening the drain valve 726. If at 912 the processing circuitry 734 determines that the residual pressure has not stabilized, the processing circuitry 734 waits at 912 for the residual pressure to stabilize. However, if at 912 the processing circuitry 734 determines that the residual pressure has stabilized, control passes to 914. At 914, the processing circuitry 734 may be configured to record residual pressure of the fire suppression agent based on the received sensor data. Residual pressure refers to pressure that remains within the fire suppression system when the fire suppression agent is flowing. At 916, the processing circuitry 734 may be configured to de-energize the first actuator 728 after the defined time duration to close the drain valve 726 to stop the flow of the fire suppression agent. At 918, the processing circuitry 734 may be configured to activate a timer and de-energize the second actuator 730 to open the inlet orifice 722 for arming the alarm assembly 706. Thus, the inlet orifice 722 of the alarm assembly 706 is closed prior to the opening of the drain valve 726 and is opened after the closing of the drain valve 726. The processing circuitry 734 activates the timer to determine how long does static pressure take to stabilize within the fire suppression system after closing the drain valve 726.

At 920, based on sensor data from the sensors 732, the processing circuitry 734 may be configured to determine whether static pressure within the fire suppression system has stabilized after closing the drain valve 726. Due to fluid dynamics and fluid inertia, the static pressure in the fire suppression system may stabilize after some time from closing the drain valve 726. If at 920 the processing circuitry 734 determines that the static pressure has not stabilized, the processing circuitry 734 waits at 920 for the static pressure to stabilize. However, if at 920 the processing circuitry 734 determines that the static pressure has stabilized, control passes to 922.

At 922, the processing circuitry 734 may be configured to record final static pressure of the fire suppression agent based on the received sensor data. Final static pressure refers to pressure within the fire suppression system when the fire suppression agent stops flowing after closing of the drain valve 726. At 924, the processing circuitry 734 may be configured to stop the timer and record the timer value. At 926, the processing circuitry 734 may be configured to determine an outcome of the drain test based on the recorded initial static pressure, the residual pressure, the final static pressure, and the timer value. The processing circuitry 734 may compare the recorded pressure data and timer value with preset thresholds for the drain test. Preset thresholds indicate permissible limits of the initial static pressure, the residual pressure, the final static pressure, and the timer value for the healthy operation of the fire suppression system.

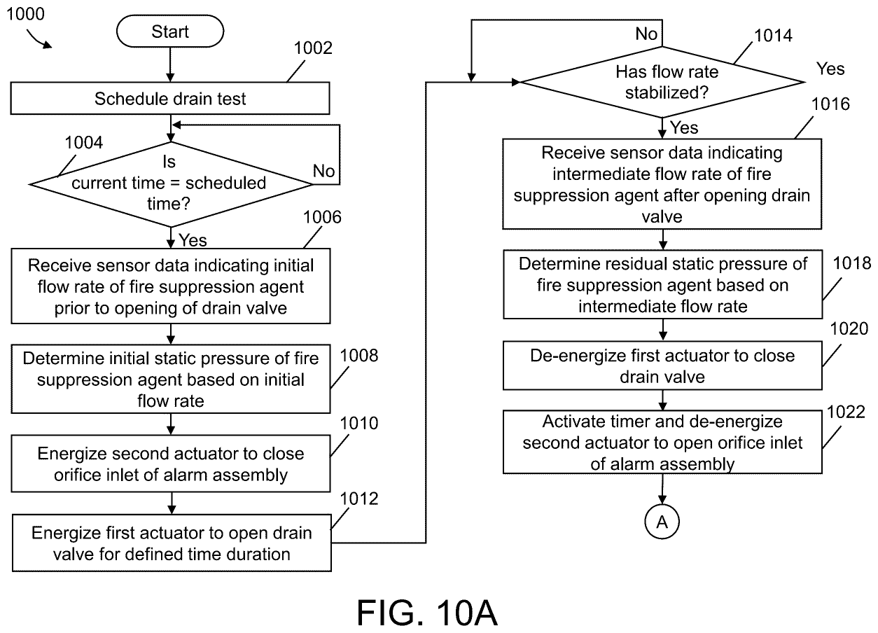

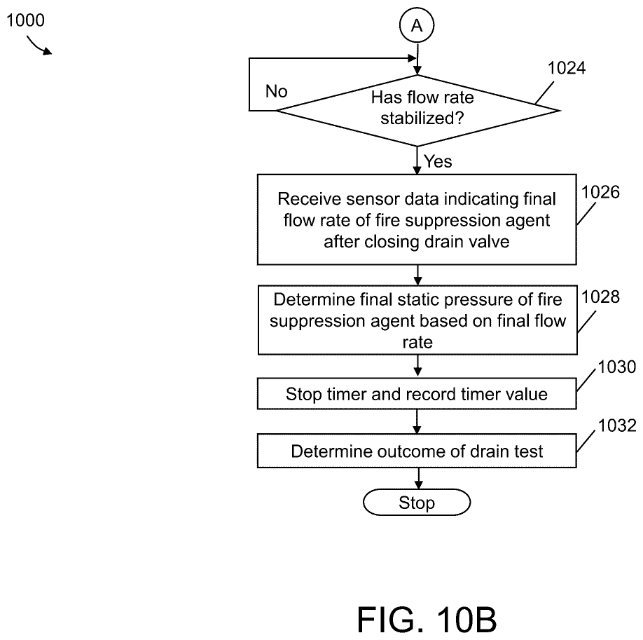

In a scenario, the automated drain test assembly may utilize flow rate sensors instead of pressure sensors. Operation of such automated drain test assembly is described in conjunction with FIGS. 10A and 10B.

Referring now to FIGS. 10A and 10B, a flow chart of a method 1000 of performing an automated drain test on a fire suppression system is shown, according to some other embodiments. In some embodiments, operations 1002-1032 of the method 400 may be performed by one or more components shown in FIG. 7.

At 1002, the processing circuitry 734 may be configured to schedule a drain test for a fire suppression system having automated drain test assembly described in foregoing description of FIG. 7. In some embodiments, the processing circuitry 734 schedule the drain test in accordance with NFPA standard. At 1004, the processing circuitry 734 may be configured to determine whether current time is same as scheduled time for the drain test. If at 1004 the processing circuitry 734 determines that the scheduled time for drain test has not arrived yet, control remains at 1004. However, if at 1004 the processing circuitry 734 determines that the scheduled time for drain test has arrived, the processing circuitry 734 starts the drain test and control passes to 1006.

At 1006, the processing circuitry 734 may be configured to receive sensor data from the sensors 232 indicating initial flow rate of the fire suppression agent prior to the opening of the drain valve 726. Ideally the initial flow rate shall be zero considering no leakage in the fire suppression system. At 1008, the processing circuitry 734 may be configured to determine initial static pressure of the fire suppression agent based on the initial flow rate indicated by the sensor data.

At 1010, the processing circuitry 734 may be configured to energize the second actuator 230 to close the inlet orifice 722 of the alarm assembly 706 to prevent triggering of false alarms during drain test. Thus, the inlet orifice 722 remains closed for the entire duration of the drain test. At 1012, the processing circuitry 734 may be configured to energize the first actuator 228 to open the drain valve 726 for a defined time duration. Thus, causing the fire suppression agent to discharge via the drain valve 726 for the defined time duration. At 1014, based on sensor data from the sensors 232, the processing circuitry 734 may be configured to determine whether flow rate of the fire suppression agent has stabilized after opening the drain valve 726. Due to fluid dynamics and fluid inertia, the flow rate of the fire suppression agent may fluctuate immediately after opening the drain valve 726. If at 1014 the processing circuitry 734 determines that the flow rate has not stabilized, the processing circuitry 734 waits at 1014 for the residual pressure to stabilize. However, if at 1014 the processing circuitry 734 determines that the flow rate has stabilized, control passes to 1016.

At 1016, the processing circuitry 734 may be configured to receive sensor data from the sensors 232 indicating intermediate flow rate of the fire suppression agent after opening the drain valve 726. At 1018, the processing circuitry 734 may be configured to determine residual pressure of the fire suppression agent based on the intermediate flow rate indicated by the received sensor data. At 1020, the processing circuitry 734 may be configured to de-energize the first actuator 228 after the defined time duration to close the drain valve 726 to stop the flow of the fire suppression agent. At 1022, the processing circuitry 734 may be configured to activate a timer and de-energize the second actuator 230 to open the inlet orifice 722 for arming the alarm assembly 706. The processing circuitry 734 activates the timer to determine how long it takes for the flow rate to reduce to initial flow rate after closing the drain valve 726. At 1024, based on sensor data from the sensors 232, the processing circuitry 734 may be configured to determine whether the flow rate within the fire suppression system has stabilized (for example, to nearly zero) after closing the drain valve 726. Due to fluid dynamics and fluid inertia, the flow rate in the fire suppression system may stabilize after some time from closing the drain valve 726. If at 1024 the processing circuitry 734 determines that the flow rate has not stabilized, the processing circuitry 734 waits at 1024. However, if at 1024 the processing circuitry 734 determines that the flow rate has stabilized, control passes to 1026.

At 1026, the processing circuitry 734 may be configured to receive sensor data from the sensors 232 indicating final flow rate of the fire suppression agent after closing the drain valve 726. At 1028, the processing circuitry 734 may be configured to determine final static pressure of the fire suppression agent based on the final flow rate indicated by the received sensor data.

At 1030, the processing circuitry 734 may be configured to stop the timer and record the timer value. At 1030, a visual inspection of one or more components of the sprinkler system can be performed, such as by operation of an image capture device. This can include, for example, monitoring a leak and/or leak state of a seal of the pump. In some examples, the processing circuitry 734 applies pattern recognition or image recognition to compare the current state of the components against predefined model components that represent normal operational states. For example, the digital twin and/or graph data structure representations of components of the sprinkler system 650 and/or testing system 600 may define normal operational states of the various sprinkler system components.

At 1032, the processing circuitry 734 may be configured to determine an outcome of the drain test based on the recorded initial static pressure, the residual pressure, the final static pressure, and the timer value. The processing circuitry 734 may compare the recorded pressure data and timer value with preset thresholds for the drain test. Preset thresholds indicate permissible limits of the initial static pressure, the residual pressure, the final static pressure, and the timer value for the healthy operation of the fire suppression system.

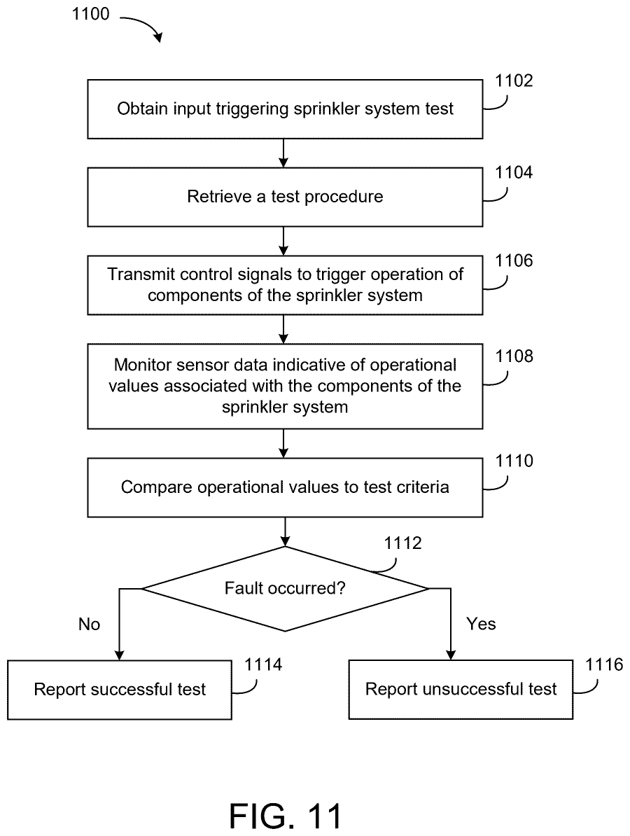

Referring to FIG. 11, a flow diagram of a method 1100 for automating reporting outcomes of automated testing of one or more components of a building system, according to an embodiment. The method 1100 can be performed using various systems described herein, such as the systems 500, 600, 700. While the method 800 is described with reference to sprinkler system testing, various operations of the method 800 can be implemented for various building subsystem tests.

At 1102, a controller (e.g., the BMS controller 12, the test manager 604, etc.) obtains an input triggering a test of the sprinkler system. The controller is remote from the sprinkler system being tested, according to an embodiment. In this way, the controller can remotely manage tests for multiple buildings and multiple sprinkler systems. In some examples, the triggering input may be a user action, such as manually setting the fire control panel 620 to a test mode. In other examples, the controller may retrieve a preset test schedule that automatically triggers tests at predefined intervals (e.g., according to standards set by NFPA, UL, and/or FM). For example, a regulatory authority may require monthly testing of certain water flow devices and quarterly or annual testing of control valves (e.g., the drain valve 726).

At 1104, the controller retrieves a test procedure for testing one or more components of the sprinkler system from a data structure storing a representation of the sprinkler system. For example, the controller may retrieve the test procedure from the test manager 604. The test procedure can include, for example, a sequence of operations to test be performed on the one or more components of the sprinkler system 650, and can include triggers associated with the operations (e.g., responsive to a first operation being performed on a first component causing a first result, a second operation can be selected to be performed on a second component; responsive to the first operation causing a second result, a third operation can be selected, where the third operation can be an operation to perform on the second component or a third component, or can be a trigger for data processing and/or output, e.g., for alarm output). The test procedure can include criteria set by one or more regulatory authorities (e.g., NFPA, UL, FM) for target performance of the sprinkler system 650. For example, the criteria can include various threshold operational values, such as, for example, threshold values for static and residual pressure, pump pressure, water flow rate, activation temperature (e.g., for sprinkler heads), and timing criteria (e.g., minimum fill time, minimum time to reach pressure setpoint, etc.). In some examples, the controller may retrieve from the twin manager 508, digital twin and/or graph data structure representations of components of the sprinkler system 650 and/or testing system 600 that digitally map the location of the components to actuate. In this way, the controller identifies components of existing sprinkler systems 650 (e.g., drains, pumps, valves, etc.) to inspect and test based on the digital twin of the sprinkler system 650.

At 1106, the controller transmits control signals to actuators coupled to components of the sprinkler system to trigger operation of the actuators. For example, the actuators 624 can be used to activate or trigger operation of one or more corresponding components of the sprinkler system 650, such as valves, flow switches, and/or pumps. At 1108, the controller receives sensor data indicative of operational values associated with the components of the sprinkler system activated at 1106. For example, the sensor data may include pressure readings from a pressure sensor before and after opening the drain valve 726. The controller can analyze this data to determine whether the system meets threshold static and residual pressure levels.

At 1110, the controller compares the operational values measured by the sensors to the test criteria. If any component fails to meet/satisfy corresponding test criteria, a fault is logged. By way of example, the controller may compare the determined static pressure and residual pressure of the sprinkler system 650 during the test to a threshold value. If the residual pressure dropped lower than the static pressure by a threshold value (e.g., pressure dropped 10% or more) then the controller determines a fault occurred at 1112. Similarly, the controller may compare the flow rate of water, or other fire suppressant, traveling through the sprinkler system 650 during the test to a minimum threshold. If the flow rate falls below the minimum threshold (e.g., <250 gpm, <500 gpm, etc.), the controller determines a fault occurred at 1112. The controller continues the comparison process for each component of the sprinkler system being tested. To allow for remote inspection to be performed, the testing system 600 can perform at least one of visual or communicative monitoring of the fire control panel 620 (e.g., by communication using the gateway and/or use of an image capture device to capture images of output indicators of the fire control panel 620).

At 1114, the controller reports a successful test, responsive to each of the components of the sprinkler system meeting corresponding criteria (e.g., satisfying a corresponding threshold). In some examples, the controller stores the report of a successful test on an internal memory or database. Additionally or alternatively, the controller may generate a user interface including a graphical representation of the successful test and may cause a display device to display the user interface (e.g., the user device 576, client devices 448, remote systems and applications 444). The representation can be a dashboard, such as a centralized dashboard for visualization of the outcome of the test (e.g., successful or unsuccessful) and/or progress of the test, including for real-time or near real-time presentation. The representation can include test outcomes for each individual component tested. If a component fails to meet the one or more criteria, the representation may detail the deviation of the operational values from the required thresholds. For example, if a valve failed to achieve a threshold flow rate, the report might show that it achieved only 85% of the minimum flow rate.

At 1116 the controller reports an unsuccessful test, responsive to at least one of the components of the sprinkler system failing to satisfy corresponding criteria (e.g., failing to satisfy a corresponding threshold). In some examples, the controller stores the report of an unsuccessful test on an internal memory or database. Additionally or alternatively, the controller may generate a user interface including a graphical representation of the successful test and may cause a display device to display the user interface (e.g., the user device 576, client devices 448, remote systems and applications 444). In some examples, the controller activates an auditory or visual alarm to notify users of an unsuccessful test (e.g., on the fire control panel 620, user device 576, client devices 448, remote systems and applications 444, etc.). In some examples, the controller determines which component failed to satisfy the corresponding criteria and runs a diagnostic. The controller may generate one or more recommendations for troubleshooting the fault (e.g., by applying a machine learning model, a generative AI model, rules based logic, etc.). The controller may generate and display a user interface that includes the recommendation. In some examples, the user interface includes images captured by an image capture device (e.g., a camera) associated with one or more components of the sprinkler system. In this way, a user may remotely inspect images of the one or more components of the sprinkler system captured during a test, or in real time.

In some examples, responsive to determining that a fault occurred at 1112, the controller may generate one or more maintenance requests based on the detected fault. For example, if the time to restore static pressure exceeds a threshold, this could indicate a partial blockage or clog in the supply source, such as a narrowed pipe or an obstruction in the pump. Responsive to identifying a type of fault, the controller can generate a maintenance request. The request may contain specific information, such as the suspected cause of the fault (e.g., a clogged supply source, blocked valve, blocked pump, etc.), the affected components (e.g., pumps, pipes, or valves), and diagnostic data supporting the determination (e.g., pressure readings and time-to-pressure data). The controller may generate troubleshooting instructions for the maintenance requests. For example, the controller might recommend inspecting the valve for debris, testing the pump motor, or flushing the pipe. The controller can prioritize the maintenance request based on the severity of the fault. For example, a blockage in the water supply system may be flagged as a high-priority issue, prompting immediate action. In some examples, the controller may automatically order replacement parts or materials required to address the fault. Details of the order may be recorded on the maintenance request (e.g., part number, order status, warehouse location, etc.).

The construction and arrangement of the systems and methods as shown in the various exemplary implementations are illustrative only. Although only a few implementations have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative implementations. Other substitutions, modifications, changes, and omissions may be made in the design, operating conditions and arrangement of the exemplary implementations without departing from the scope of the present disclosure.

The present disclosure contemplates methods, systems and program products on any machine-readable media for accomplishing various operations. The implementations of the present disclosure may be implemented using existing computer processors, or by a special purpose computer processor for an appropriate system, incorporated for this or another purpose, or by a hardwired system. Implementations within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

In various implementations, the steps and operations described herein may be performed on one processor or in a combination of two or more processors. For example, in some implementations, the various operations could be performed in a central server or set of central servers configured to receive data from one or more devices (e.g., edge computing devices/controllers) and perform the operations. In some implementations, the operations may be performed by one or more local controllers or computing devices (e.g., edge devices), such as controllers dedicated to and/or located within a particular building or portion of a building. In some implementations, the operations may be performed by a combination of one or more central or offsite computing devices/servers and one or more local controllers/computing devices. All such implementations are contemplated within the scope of the present disclosure. Further, unless otherwise indicated, when the present disclosure refers to one or more computer-readable storage media and/or one or more controllers, such computer-readable storage media and/or one or more controllers may be implemented as one or more central servers, one or more local controllers or computing devices (e.g., edge devices), any combination thereof, or any other combination of storage media and/or controllers regardless of the location of such devices.

What is claimed:

1. A building management system (BMS) comprising one or more memory devices storing instructions thereon that, when executed by one or more processors, cause the one or more processors to perform operations comprising:
obtaining an input triggering a test of a sprinkler system within a building associated with the BMS;
retrieving a test procedure responsive to obtaining the input, the test procedure comprising one or more criteria regarding operation of one or more components of the sprinkler system;
transmitting one or more control signals to trigger operation of one or more components of the sprinkler system according to the test procedure;
monitoring sensor data indicative of one or more operational values associated with the one or more components of the sprinkler system;
determining whether a fault has occurred in at least one of the components of the sprinkler system during the test procedure based on evaluation of the operational value using the one or more criteria; and
reporting (1) a successful test of the sprinkler system responsive to determining that no faults occurred in the one or more components of the sprinkler system during the test procedure or (2) reporting an unsuccessful test of the sprinkler system responsive to determining one or more faults occurred in at least one of the one or more components of the sprinkler system during the test procedure.

2. The BMS of claim 1, wherein the operations further comprise:
transmitting a first control signal to trigger operation of a first actuator to activate a drain of the sprinkler system;
monitoring one or more pressures associated with the drain to validate operation of the drain;
transmitting a second control signal to trigger operation of the first actuator or a second actuator to activate a flow switch of the sprinkler system;
monitoring one or more state signals from the flow switch to validate operation of the flow switch;
transmitting a third control signal to trigger operation of one of the first actuator, the second actuator, or a third actuator to activate a pump of the sprinkler system;
monitoring one or more state signals from the pump to validate operation of the pump;
processing one or more images from an image capture device having a field of view corresponding to the sprinkler system to perform image-based validation of the sprinkler system; and
reporting at least one of (a) the one or more pressures associated with the drain, (b) the one or more state signals from the flow switch, (c) the one or more state signals from the pump, or (d) the one or more images from the image capture device.

3. The BMS of claim 2, further comprising transmitting the second control signal responsive to the operation of the drain being validated.

4. The BMS of claim 2, wherein the image capture device is triggered to capture images of the one or more components of the sprinkler system responsive to the input triggering the test, or responsive to an input to perform remote inspection of the one or more components of the sprinkler system.

5. The BMS of claim 1, wherein the sprinkler system comprises a first zone for which the test is to be performed and a second zone for which the test is not to be performed, and wherein the operations further comprise:
identifying, based on a data structure storing a representation of the sprinkler system, an image capture device or a sensor associated with the first zone;
performing an inspection of one or more images retrieved from the image capture device or data retrieved from the sensor to detect one or more features corresponding to a predetermined condition regarding operation of the sprinkler system; and
evaluating the one or more criteria further based on the one or more detected features.

6. The BMS of claim 1, wherein the building is a first building of a plurality of buildings associated with the BMS and the sprinkler system is a first sprinkler system.

7. The BMS of claim 6, wherein the operations further comprise:
transmitting one or more control signals to trigger operation of one or more components of a second sprinkler system within a second building according to the test procedure;
monitoring sensor data indicative of one or more operational values associated with the one or more components of the second sprinkler system;
determining whether a fault has occurred in at least one of the components of the second sprinkler system during the test procedure based on evaluation of the operational value using the one or more criteria; and
reporting (1) a successful test of the second sprinkler system responsive to determining that no faults occurred in the one or more components of the second sprinkler system during the test procedure or (2) reporting an unsuccessful test of the second sprinkler system responsive to determining one or more faults occurred in at least one of the one or more components of the second sprinkler system during the test procedure.

8. The BMS of claim 7, wherein the operations further comprise generating a user interface having graphical representations of outcomes of the test of the first sprinkler system and the second sprinkler system.

9. The BMS of claim 1, wherein the operations further comprise obtaining a test schedule that automatically triggers tests of the sprinkler system.

10. The BMS of claim 1, wherein the operations further comprise, responsive to determining that a fault occurred in at least one of the components of the sprinkler system, generating a recommendation for resolving the fault.

11. The BMS of claim 1, wherein the operations further comprise, responsive to determining that a fault occurred in at least one of the components of the sprinkler system:
determining a type of fault; and
generating, based on the type of fault, a maintenance request for a site visit.

12. The BMS of claim 1, wherein initiating the test comprises remotely setting a fire control panel coupled with the sprinkler system to a test mode.

13. A method comprising:
obtaining an input triggering a test of a sprinkler system within a building;
retrieving a test procedure responsive to obtaining the input, the test procedure comprising one or more criteria regarding operation of one or more components of the sprinkler system;
transmitting one or more control signals to trigger operation of the one or more components of the sprinkler system according to the test procedure;
monitoring sensor data indicative of one or more operational values associated with the one or more components of the sprinkler system;
determining whether a fault has occurred in at least one of the components of the sprinkler system during the test procedure based on evaluation of the operational value using the one or more criteria; and
reporting (1) a successful test of the sprinkler system responsive to determining that no faults occurred in the one or more components of the sprinkler system during the test procedure or (2) reporting an unsuccessful test of the sprinkler system responsive to determining one or more faults occurred in at least one of the one or more components of the sprinkler system during the test procedure.

14. The method of claim 13, further comprising:
transmitting a first control signal to trigger operation of a first actuator to activate a drain of the sprinkler system;
monitoring one or more pressures associated with the drain to validate operation of the drain;
transmitting a second control signal to trigger operation of the first actuator or a second actuator to activate a flow switch of the sprinkler system;
monitoring one or more state signals from the flow switch to validate operation of the flow switch;
transmitting a third control signal to trigger operation of one of the first actuator, the second actuator, or a third actuator to activate a pump of the sprinkler system;
monitoring one or more state signals from the pump to validate operation of the pump;
processing one or more images from an image capture device having a field of view corresponding to the sprinkler system to perform image-based validation of the sprinkler system; and
reporting at least one of (a) the one or more pressures associated with the drain, (b) the one or more state signals from the flow switch, (c) the one or more state signals from the pump, or (d) the one or more images from the image capture device.

15. The method of claim 13, wherein the building is a first building of a plurality of buildings and the sprinkler system is a first sprinkler system.

16. The method of claim 15, further comprising:
transmitting one or more control signals to trigger operation of one or more components of a second sprinkler system within a second building according to the test procedure;
monitoring sensor data indicative of one or more operational values associated with the one or more components of the second sprinkler system to validate operation of the one or more components of the second sprinkler system;
comparing the one or more operational values to corresponding criteria;
determining whether a fault has occurred in at least one of the components of the second sprinkler system during the test procedure based on the operational value satisfying the one or more criteria;
responsive to determining no faults occurred in the one or more components of the second sprinkler system during the test procedure, reporting a successful test of the second sprinkler system; and
responsive to determining one or more faults occurred in at least one of the one or more components of the second sprinkler system during the test procedure, reporting an unsuccessful test of the second sprinkler system.

17. The method of claim 16, further comprising generating a user interface having graphical representations of outcomes of the test of the first sprinkler system and the second sprinkler system.

18. A method, comprising:
identifying, by one or more processors, a plurality of components of a building system, the building system comprising at least one of a security system, a fire protection system, a sprinkler system, or an HVAC system;
selecting, by the one or more processors, by processing at least one of a graph data structure or a digital twin representative of the building system according to respective identifiers of the plurality of components, at least one of an activator or a sensor coupled with each component of the plurality of components; and
testing, by the one or more processors, each component of the plurality of components by at least one of operating the activator or evaluating sensor data from the sensor relative to one or more criteria for the component.

19. The method of claim 18, further comprising updating the at least one of the graph data structure or the digital twin according to the sensor data.

20. The method of claim 18, further comprising performing the testing of each component of the plurality of components according to an order of operations represented in a test data structure maintained by the at least one of the digital twin or the graph data structure, and presenting a dashboard comprising output of the testing.
